(19) United States
(12) Patent Application Publication
(10) Pub. No.: US 2025/0189720 A1
(43) Pub. Date: Jun. 12, 2025

(54) OPTICAL WAVEGUIDE, SEMICONDUCTOR DEVICE WITH OPTICAL WAVEGUIDE, AND METHODS OF MANUFACTURING THE SAME

(71) Applicant: Taiwan Semiconductor Manufacturing Company, Ltd., Hsinchu (TW)

(72) Inventors: Chun-Hao Fann, New Taipei City (TW); Wei-Heng Lin, Taipei City (TW); Hsing-Kuo Hsia, Hsinchu County (TW); Chen-Hua Yu, Hsinchu City (TW); Tien-Lin Shen, Taipei City (TW)

(73) Assignee: Taiwan Semiconductor Manufacturing Company, Ltd., Hsinchu (TW)

(21) Appl. No.: 18/533,054

(22) Filed: Dec. 7, 2023

(51) Int. Cl. G02B 6/122

(52) U.S. Cl. CPC G02B 6/1228

(57) ABSTRACT

An optical waveguide includes a first portion, a second portion, and a third portion. The first portion includes an input port configured to allow an input optical signal of a first propagation direction entering therefrom. The second portion includes a taper waveguide portion configured to expanding the input optical signal and a rectangular waveguide portion configure to split the input optical signal, where the rectangular waveguide portion is connected to the taper waveguide portion. The third portion includes at least one output port configured to allow an output optical signal of an output propagation direction exiting therefrom, where the output propagation direction is different from the first propagation direction. The second portion is sandwiched between the first portion and the third portion.

### BACKGROUND

Recently, optical signaling and processing have been widely used in many applications. As optical signaling and processing for long-range signal transmission are often combined with electrical signaling and processing for short-range signal transmission, a photonic die for optical signaling and processing and an electronic die for electrical signaling and processing are integrated in the same semiconductor package, to shorten signal path between the photonic die and the electronic die. Currently, there is still room for improving efficiency of optical signal coupling between the photonic die and an external fiber.

### BRIEF DESCRIPTION OF THE DRAWINGS

Aspects of the disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 to FIG. 6 are schematic plane or cross-sectional views of various stages in manufacturing a waveguide in accordance with some embodiments of the disclosure.

FIG. 7 through FIG. 10 are schematic enlarged, plane views respectively showing various embodiments of a waveguide in accordance with the disclosure.

FIG. 11 is a flow chart illustrating a method for manufacturing a waveguide in accordance with some embodiments of the disclosure.

FIG. 12 to FIG. 15 are schematic plane or cross-sectional views of various stages in manufacturing a semiconductor device with a waveguide in accordance with some embodiments of the disclosure.

FIG. 16 is a schematic cross-sectional view of a configuration of a semiconductor device and an external light source in accordance with some embodiments of the disclosure.

FIG. 17 is a schematic cross-sectional view of a configuration of a semiconductor device and an external light source in accordance with some embodiments of the disclosure.

FIG. 18 is a schematic cross-sectional view of a semiconductor package in accordance with some embodiments of the disclosure.

### DETAILED DESCRIPTION

The following disclosure provides many different embodiments, or examples, for implementing different features of the provided subject matter. Specific examples of components, values, operations, materials, arrangements, or the like, are described below to simplify the disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In addition, terms, such as “first”, “second”, “third”, “fourth”, “fifth”, “sixth”, “seventh”, and the like, may be used herein for ease of description to describe similar or different element(s) or feature(s) as illustrated in the figures, and may be used interchangeably depending on the order of the presence or the contexts of the description.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

Other features and processes may also be included. For example, testing structures may be included to aid in the verification testing of the 3D packaging or 3DIC devices. The testing structures may include, for example, test pads formed in a redistribution layer or on a substrate that allows the testing of the 3D packaging or 3DIC, the use of probes and/or probe cards, and the like. The verification testing may be performed on intermediate structures as well as the final structure. Additionally, the structures and methods disclosed herein may be used in conjunction with testing methodologies that incorporate intermediate verification of known good dies to increase the yield and decrease costs.

It should be appreciated that the following embodiment(s) of the disclosure provides applicable concepts that can be embodied in a wide variety of specific contexts. The embodiments are intended to provide further explanations but are not used to limit the scope of the disclosure. The specific embodiment(s) described herein is related to a waveguide (or an optical coupler) having an input port and multiple output ports, where a propagating direction of an optical signal entering the input port are different from propagating directions of optical signals exiting the output ports, and is not intended to limit the scope of the disclosure. Due to the waveguide (or the optical coupler) of the disclosure, a compact and simple design is achieved, and the power mismatch is at least less than 0.1 dB. That is to say, a semiconductor device of a compact fan-out design is obtained by adopting one or more waveguides (or the optical couplers) of the disclosure therein, where the varieties in one or more waveguides (or the optical couplers) of the disclosure promotes the more compact design of the semiconductor device, which can be used as a passive library device for photonic circuit structure.

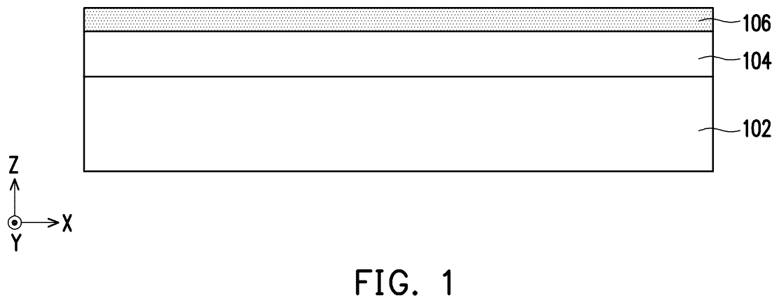

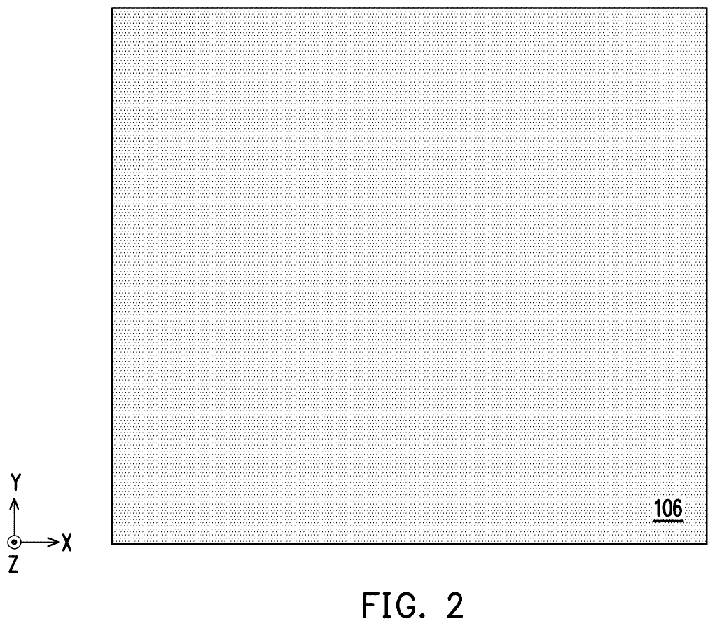

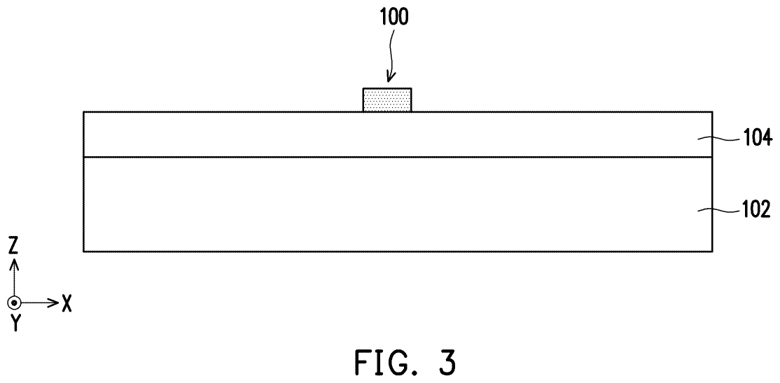

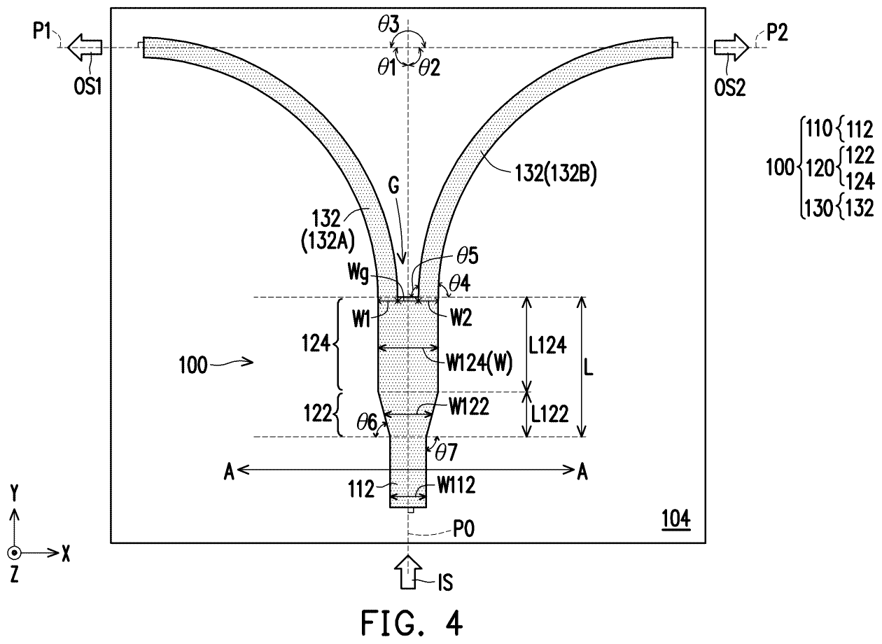

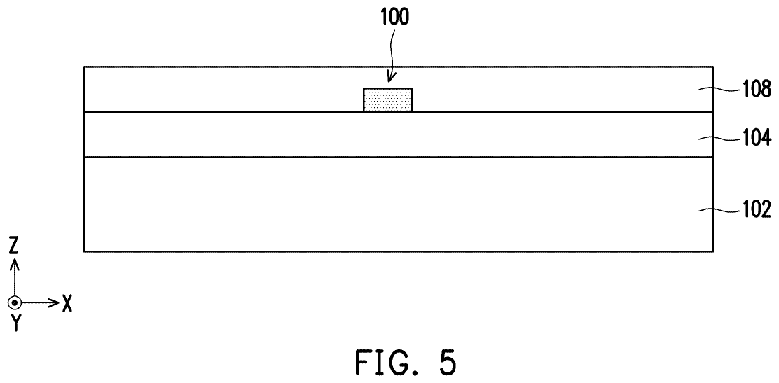

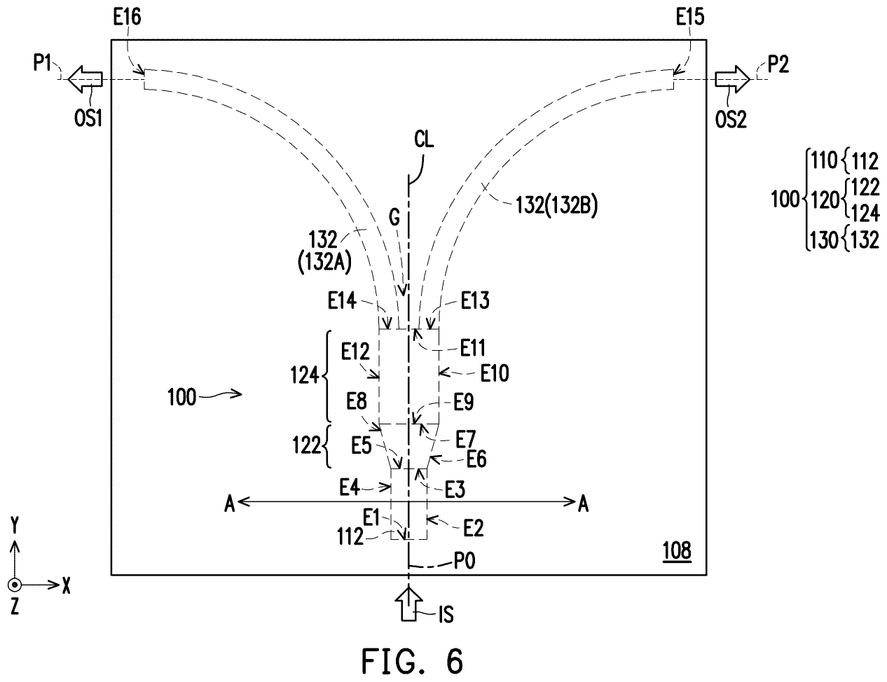

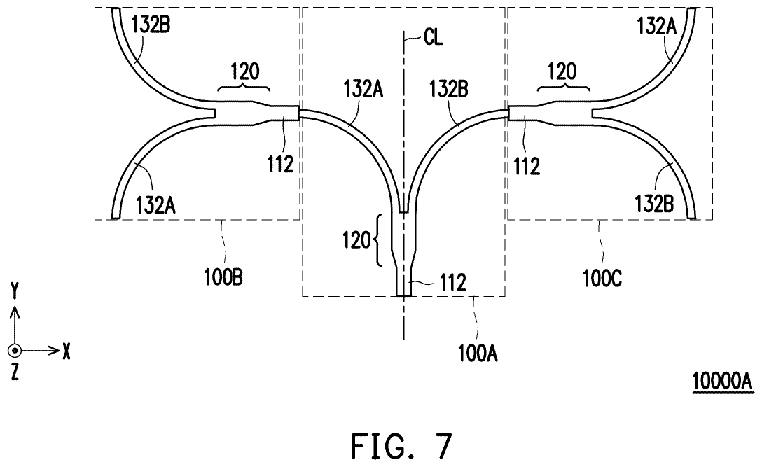

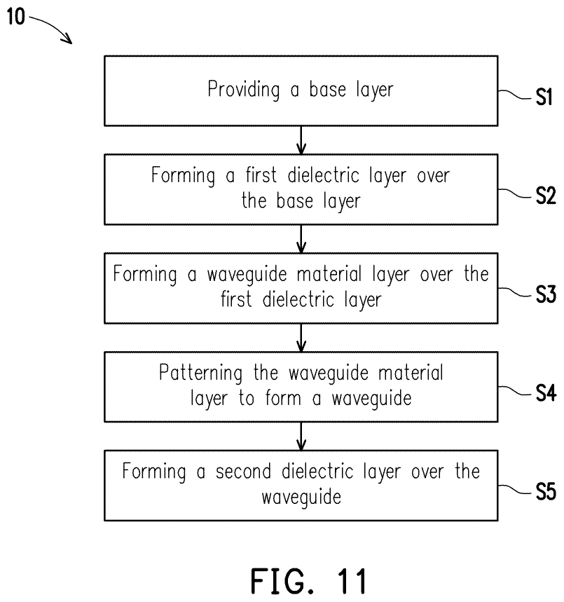

FIG. 1 to FIG. 6 are schematic plane or cross-sectional views of various stages in manufacturing a waveguide 100 in accordance with some embodiments of the disclosure, where the schematic cross-sectional views of FIG. 1, FIG. 3, and FIG. 5 are taken along with a line A-A depicted in the schematic plane views of FIG. 2, FIG. 4, and FIG. 6, respectively. FIG. 7 through FIG. 10 are schematic enlarged, plane views respectively showing various embodiments of a waveguide in accordance with the disclosure. FIG. 11 is a flow chart illustrating a method 10 for manufacturing a waveguide in accordance with some embodiments of the disclosure. In some embodiments, the manufacturing method is part of a wafer level packaging process. It is understood that additional processes may be provided before, during, and after the illustrated method, and that some other processes may only be briefly described herein. In the disclosure, it should be appreciated that the illustration of components throughout all figures is schematic and is not in scale. Throughout the various views and illustrative embodiments of the disclosure, the elements similar to or substantially the same as the elements described previously will use the same reference numbers, and certain details or descriptions (e.g., the materials, formation processes, positioning configurations, electrical connections, etc.) of the same elements would not be repeated. For clarity of illustrations, the drawings are illustrated with orthogonal axes (X, Y and Z) of a Cartesian coordinate system according to which the views are oriented; however, the disclosure is not specifically limited thereto.

Referring to FIG. 1 and FIG. 2, in some embodiments, a base layer 102 is provided; in accordance with a step S1 of the method 10 depicted in FIG. 11. In some embodiments, the base layer 102 may be a conductive layer, a semiconductor layer, or an insulating layer. Alternatively, the base layer 102 may be any suitable carrier with sufficient support during manufacturing the waveguide 100 (depicted in FIG. 5 and FIG. 6), such as reconstituted wafer, a glass substrate or a ceramic substrate. The disclosure is not limited thereto.

For example, the conductive layer may be a layer formed of a metal or a metal alloy. Examples of the metal or metal alloy may be tungsten (W), cobalt (Co), copper (Cu), aluminum (Al), nickel (Ni), ruthenium (Ru), gold (Au), silver (Ag), molybdenum (Mo), manganese (Mg), zirconium (Zr), other suitable materials, and/or combinations thereof, where the conductive layer may be formed by deposition, electroplating, electroless plating, other suitable processes, and/or combinations thereof.

For example, the semiconductor layer may be a layer formed of a semiconductor material. Examples of semiconductor material may be silicon (Si), germanium (Ge), silicon carbide (SiC), gallium arsenide (GaAs), gallium phosphide (GaP), indium phosphide (InP), indium arsenide (InAs), gallium arsenide phosphide (GaAsP), aluminum indium arsenide (AlInAs), aluminum gallium arsenide (AlGaAs), gallium indium arsenide (GaInAs), gallium indium phosphide (GaInP), gallium indium arsenide phosphide (GaInAsP), indium antimonide (InSb), silicon germanium (SiGe), and/or any other suitable semiconductor material, where the semiconductor layer may be formed by deposition.

For example, the insulating layer may be a layer formed of a dielectric material. Examples of the dielectric material may be an oxide, such as silicon oxide or silicon oxynitride; a nitride, silicon nitride or silicon carbon nitride; a polymer-based dielectric material, such as polyimide, epoxy resin, acrylic resin, phenol resin, benzocyclobutene (BCB), polybenzooxazole (PBO), and/or any other suitable polymer-based dielectric material, where the dielectric layer may be formed by deposition. The aforesaid deposition process may include, but may not be limited to, chemical vapor deposition (CVD) (such as plasma-enhanced CVD (PECVD) or the like), physical vapor deposition (PVD), atomic layer deposition (ALD), other suitable processes, and/or combinations thereof, for example. In some alternative embodiments, the dielectric material may include metal oxides or metal nitrides. Examples of the metal oxide includes ZrO₂, Gd₂O₃, HfO₂, BaTiO₃, Al₂O₃, LaO₂, TiO₂, Ta₂Os, Y₂O₃, STO, BTO, BaZrO, HfZrO, HfLaO, HfTaO, HfTiO, or the like. Examples of the metal nitride includes TiN, TaN, WN, TiAlN, TaCN, or the like. In some further alternative embodiments, the dielectric material may include a silicate such as HfSiO, HfSiON, LaSiO, AlSiO, or the like.

In some embodiments, as shown in FIG. 1, a first dielectric layer 104 is formed over the base layer 102; in accordance with a step S2 of the method 10 depicted in FIG. 11. As shown in FIG. 1, the first dielectric layer 104 may be globally formed on the base layer 102. In some embodiments, the first dielectric layer 104 is in physical contact with the base layer 102. The first dielectric layer 104 is a conformal layer of dielectric material, for example. In some embodiments, the first dielectric layer 104 is an oxide layer, such as a silicon oxide layer or the like. A thickness (e.g., in a direction Z) of the first dielectric layer 104 may be approximately ranging from 0.5 μm to 4 μm, although other suitable thickness may alternatively be utilized.

It should be understood that the first dielectric layer 104 may include one or more dielectric materials. The first dielectric layer 104 may include a single-layer structure or a multilayer structure. The first dielectric layer 104 may be formed to a suitable thickness by CVD (such as flowable chemical vapor deposition (FCVD), high-density plasma CVD (HDP-CVD) and sub-atmospheric CVD (SACVD) or the like) or other suitable methods. Herein, when a layer is described as conformal or conformally formed, it indicates that the layer has a substantially equal thickness extending along the region on which the layer is formed.

In some embodiments, as shown in FIG. 1, a waveguide material layer 106 is formed over the first dielectric layer 104; in accordance with a step S3 of the method 10 depicted in FIG. 11. As shown in FIG. 1, the waveguide material layer 106 may be globally formed on the first dielectric layer 104. In some embodiments, the waveguide material layer 106 is in physical contact with the first dielectric layer 104. For example, the first dielectric layer 104 is disposed sandwiched between the base layer 102 and the waveguide material layer 106. In such case, an illustrated top surface (not label) of the first dielectric layer 104 is in direct contact with the waveguide material layer 106, while an illustrated bottom surface (not label) is in direct contact with the base layer 102, where the illustrated top surface of the first dielectric layer 104 is opposite to the illustrated bottom surface of the first dielectric layer 104 along the direction Z (may be referred to as a stacking direction).

The waveguide material layer 106 is a conformal layer of waveguide material, for example. In some embodiments, the waveguide material layer 106 is a nitride layer, such as a silicon nitride layer or the like. A thickness (e.g., in the direction Z) of the waveguide material layer 106 may be less than 2 μm, although other suitable thickness may alternatively be utilized. The thickness (e.g., in the direction Z) of the waveguide material layer 106 may be approximately ranging from 0.1 μm to 1.5 μm, in a non-limiting example. The waveguide material layer 106 may be formed to a suitable thickness by CVD (such as FCVD, HDP-CVD and SACVD or the like) or other suitable methods. In some embodiments, the material of the waveguide material layer 106 is different from the material of the first dielectric layer 104. In some embodiment, the refractive index of the material of the waveguide material layer 106 is higher than the refractive index of the material of the first dielectric layer 104.

Referring to FIG. 3 and FIG. 4, in some embodiments, the waveguide material layer 106 is patterned to form the waveguide 100 on the first dielectric layer 104 over the base layer 102; in accordance with a step S4 of the method 10 depicted in FIG. 11. The waveguide 100 is considered as an optical device or photonic component of the disclosure, in some embodiments; and may be referred to as a waveguide structure, an optical waveguide, an optical waveguide structure, an optical splitter, or an optical coupler. For example, the waveguide 100 is directly disposed on (e.g., in physical contact with) the illustrated top surface of the first dielectric layer 104. The pattering process may include suitable photolithography and etching techniques. Only one waveguide 100 is shown in FIG. 3 through FIG. 6 for illustrative purposes and simplicity, the number of the waveguides formed from the waveguide material layer 106 can designated based on the demand and design requirement. The disclosure is not limited thereto.

For example, a hardmask layer (not shown) may be formed over the waveguide material layer 106 and then patterned. The pattern of the hardmask layer may then be transferred to the waveguide material layer 106 to form the waveguide 100 using one or more etching techniques, such as dry etching and/or wet etching techniques. For example, the waveguide material layer 106 may be etched to form one or more recesses defining the waveguide 100, with the remaining unrecessed portions of the waveguide material layer 106 forming the waveguide 100, with sidewalls of the remaining unrecessed portions defining sidewalls of the waveguide 100. In some embodiments, the hardmask layer may be formed of the photosensitive material such as a positive resist material or a negative resist material, that is suitable for a patterning process such as a photolithography process with a mask or a mask-less photolithography process (such as an electron-beam (e-beam) writing or an ion-beam writing). After forming the waveguide 100, the hardmask layer may be removed by acceptable ashing process and/or photoresist stripping process, such as using an oxygen plasma or the like, and the disclosure is not limited thereto. In some embodiments, more than one photolithography and etching sequence may be used in order to pattern the waveguide material layer 106.

As illustrated in FIG. 3 and FIG. 4, in some embodiments, the waveguide 100 includes a first portion 110, a second portion 120 and a third portion 130, where the second portion 120 is connected to the first portion 110 and the third portion 130 at two different sides (e.g., E1 and E2 depicted in FIG. 6) of the second portion 120 along a direction Y. Alternatively, the waveguide 100 may include a first portion 110, a second portion 120 and a third portion 130, where the second portion 120 may be connected to the first portion 110 and the third portion 130 at two different sides of second portion 120 along a direction X. The direction X may be different from the direction Y, and the directions X and Y may be different from the direction Z. For example, the direction Y and the direction X direction are perpendicular to each other, and the direction Y and the direction X are perpendicular to the direction Z. The directions Y and X may be referred to as lateral directions or horizontal directions, while the direction Z may alternatively be referred to as a vertical direction.

In some embodiments, in each waveguide 100, the first region 110 include an input port 112 (including edges E1 through E4 depicted in FIG. 6), the second region 120 includes a taper section 122 (including edges E5 through E8 depicted in FIG. 6) and a rectangular section 124 (including edges E9 through E12 depicted in FIG. 6) connecting to the taper section 122, and a third portion 130 include output ports 132 (including two end surfaces E13 and E15, or E14 and E16 depicted in FIG. 6). The taper section 122 may be referred to as a taper waveguide, a taper waveguide portion, or a taper waveguide section. The rectangular section 124 may be referred to as a rectangular waveguide, a rectangular waveguide portion, or a rectangular waveguide section. The taper section 122 is sandwiched between the input port 112 along the direction Y, and the rectangular section 124 is sandwiched between the taper section 122 and the output ports 132 (e.g., 132A, 132B) along the direction Y, for example, as shown in FIG. 4. In some embodiments, the output ports 132 are physically separated from each other by a gap G, in the direction X. In other words, the output ports 132 and the gap G interposed therebetween are laterally arranged (e.g., along the direction X) at a side (e.g., E11) of the rectangular section 124.

For the third portion 130, a width Wg (e.g., in the direction X) of the gap G at the side of the rectangular section 124 disposed with the output ports 132 may be greater than 0 μm and less than 1 μm, although other suitable width may alternatively be utilized. A width W1 (e.g., in the direction X) of the output port 132A may be greater than 0 μm and may be less than or equal to 5 μm, although other suitable width may alternatively be utilized. The width W1 of the output port 132A may be approximately ranging from 0.2 μm to 5 μm, in a non-limiting example. In some embodiments, the width W1 maintains constant throughout a lengthwise dimension of the output port 132A. A width W2 (e.g., in the direction X) of the output port 132B may be greater than 0 μm and may be less than or equal to 5 μm, although other suitable width may alternatively be utilized. The width W2 of the output port 132B may be approximately ranging from 0.2 μm to 5 μm, in a non-limiting example. In some embodiments, the width W2 maintains constant throughout a lengthwise dimension of the output port 132B. In a non-limiting example, the width W1 of the output port 132A is substantially equal to the width W2 of the output port 132B. In other non-limiting example, the width W1 of the output port 132A is different from the width W2 of the output port 132B. The width W1 of the output port 132A is greater than the width W2 of the output port 132B. The width W1 of the output port 132A is less than the width W2 of the output port 132B. The disclosure is not limited thereto.

For the second portion 120, a width W124 (e.g., in the direction X) of the rectangular section 124 may be a sum of the width Wg, the width W1 and the width W2, and a length L124 (e.g., in the direction Y) of the rectangular section 124 may be approximately ranging from 1.05 times the width W124 to 2 times the width W124, although other suitable width and/or length may alternatively be utilized. In some embodiments, the width W124 of the rectangular section 124 maintains constant throughout a lengthwise dimension (e.g., L124) of the rectangular section 124. In some embodiments, a width W122 (e.g., in the direction X) of the taper section 122 may be approximately ranging from a width W112 to the width W124. Or, the width W122 (e.g., in the direction X) of the taper section 122 may be approximately ranging from 0.7 times the width W112 to 1.3 times the width W124. In some embodiments, a length L122 (e.g., in the direction Y) of the taper section 122 may be approximately ranging from 0.2 times the width W124 to 1.2 times the width W124, although other suitable width and/or length may alternatively be utilized. In some embodiments, the width W122 of the taper section 122 gradually increased along a direction of from the input port 112 toward the rectangular section 124. For example, the width W122 of the taper section 122 is tapering from an end (or edge E7) towards its opposite end (or edge E5) in the direction Y. If considering the waveguide 100 is a single mode waveguide, an input optical signal IS is expanded through the taper section 122 of the second portion 120 and is then split into output optical signals OS1 and OS2 through the rectangular section 124. In some embodiments, the second portion 120 has an overall length L and an overall W, where the overall length L is a sum of the length L122 of the taper section 122 and the length L124 of the rectangular section 124, the overall width W is a sum of the width W1 of the output port 132A, the width W2 of the output port 132B and the width Wg of the gap G, and a ratio of the overall length L to the overall width W is approximately ranging from 3:2 to 5:2. The overall length L is approximately 1.3 times a wavelength W_{IS} to 2.0 times the wavelength W_{IS}, where W_{IS} is the wavelength of the input optical signal IS, although other suitable width may alternatively be utilized. In some embodiments, the overall length L is approximately (3/2) times the wavelength W_{IS}. In some embodiments, a ratio of the length L122 of the taper section 122 to the length L124 of the rectangular section 124 is approximately ranging from 2:7 to 8:9. Due to the second portion 120 is simple design and building blocks based, it allows using the waveguide 100 as a passive library device for photonic circuit design.

For the first portion 110, a width W112 (e.g., in the direction X) of the input port 112 may be greater than 0 μm and may be less than or equal to 5 μm, although other suitable width may alternatively be utilized. The width W112 of the input port 112 may be approximately ranging from 0.2 μm to 5 μm, in a non-limiting example. In some embodiments, the width W112 maintains constant throughout a lengthwise dimension of the input port 112.

In some embodiments, the propagating direction P0 of the input optical signal IS entering the input port 112 are different from propagating directions P2, P3 of the output optical signals OS1, OS2 exiting the output ports 132 semiconductor device. As shown in FIG. 4, an angle θ1 between the propagating direction P0 of the input optical signal IS (of the input portion 122) and the propagating direction P1 of the output optical signal OS1 (of the output port 132A) is substantially equal to 90 degrees, and an angle θ2 between the propagating direction P0 of the input optical signal IS (of the input portion 122) and the propagating direction P2 of the output optical signal OS2 (of the output port 132B) is substantially equal to 90 degrees. However, the disclosure is not limited thereto. In some embodiments, the angles θ1, θ2 independently is greater than or substantially equal to 180 degrees and is greater than zero degree. In a non-limiting example, the angle θ1 is substantially equal to the angle θ2. If the angle θ1 is zero degree, then an overall lengthwise dimension of a waveguide will be too large for compact (fan-out) design. As shown in FIG. 4, an angle θ3 between the propagating direction P1 of the output optical signal OS1 (of the output port 132A) and the propagating direction P2 of the output optical signal OS2 (of the output port 132B) is substantially equal to 180 degrees. However, the disclosure is not limited thereto. In some embodiments, the angle θ3 is less than or substantially equal to 360 degrees and is greater than zero degree. If the angle θ1 is zero degree, then an overall lengthwise dimension of a waveguide will be too large for compact (fan-out) design.

In addition, as shown in FIG. 4 in conjunction with FIG. 6, an angle θ4 between a sidewall of each of the output ports 132 proximately closed to the edge E11 of the rectangular section 124 and an extending plane of the edge E11 extending beyond the edge E10 or E12 may be about 90 degrees, an angle θ5 between a sidewall of each of the output ports 132 proximately closed to the edge E11 of the rectangular section 124 and the edge E11 may be about 90 degrees, an angle θ6 between a sidewall (e.g., E6 or E8) of the taper section 122 proximately closed to the edge E3 of the first portion 110 and an extending plane of the edge E3 extending beyond the edge E2 or E4 may be about 90 degrees, and an angle θ7 between a sidewall (e.g., E2 or E4) of the first portions 132 proximately closed to the edge E5 of the taper section 122 and the edge E5 may be about 90 degrees. In some embodiments, the waveguide 100 has a central line CL passing through a center of the first portion 110 and a center of the second portion 120, where the output ports 132 of the third portion 130 are symmetric along the central line CL. That is, a distance between the central line CL and the output port 132A is substantially equal to a distance between the central line CL and the output port 132B, for example.

Referring to FIG. 5 and FIG. 6, in some embodiments, a second dielectric layer 108 is formed over the waveguide 100; in accordance with a step S5 of the method 10 depicted in FIG. 11. As shown in FIG. 5 and FIG. 6, the second dielectric layer 108 may be globally formed on the waveguide 100 and covers the first dielectric layer 104 exposed by the waveguide 100. In some embodiments, the second dielectric layer 108 is in physical contact with the waveguide 100 and the first dielectric layer 104 exposed therefrom. The second dielectric layer 108 is a conformal layer of dielectric material, for example. In some embodiments, the second dielectric layer 108 is an oxide layer, such as a silicon oxide layer or the like. A thickness (e.g., in a direction Z) of the second dielectric layer 108 may be approximately ranging from 0.5 μm to 4 μm, although other suitable thickness may alternatively be utilized. In a non-limiting example, the material of the second dielectric layer 108 and the material of the first dielectric layer 104 is the same. The material of the second dielectric layer 108 is different from the material of the waveguide 100. It should be understood that the second dielectric layer 108 may include one or more dielectric materials. The second dielectric layer 108 may include a single-layer structure or a multilayer structure. The second dielectric layer 108 may be formed to a suitable thickness by CVD (such as FCVD, HDP-CVD and SACVD or the like) or other suitable methods.

In some embodiments, the material of the waveguide 100 is different from the material of the first dielectric layer 104 and the material of the second dielectric layer 108. In some embodiments, the refractive index of the material of the waveguide 100 is higher than the refractive index of the material of the first dielectric layer 104 and the refractive index of the material of the second dielectric layer 108. As shown in FIG. 5 and FIG. 6, the waveguide 100 is completely enclosed by (e.g., entirely surrounded by) the first dielectric layer 104 and the second dielectric layer 108. Due to the difference in refractive indices of the material of the waveguide 100 and the material of the first and second dielectric layers 104, 108, the waveguide 100 may have high internal reflections that confine light (e.g., optical signals or optical power) within the waveguide 100. Up to here, the optical signals or optical power can enter and be transmitted inside the waveguide 100 enclosed by the first and second dielectric layers 104 and 108 and then split into multiple portions of optical signals or optical powers as exiting the waveguide 100. In a non-limiting example, a splitting ratio of the output optical signal OS1 of the output ports 132A to the output optical signal OS2 of the output ports 132B is 50:50. In other non-limiting example, the splitting ratio of the output optical signal OS1 of the output ports 132A to the output optical signal OS2 of the output ports 132B is 40:60, 30:70, 20:80, or 10:90. Due to the waveguide 100, a compact and simple design of an optical network can be achieved, and the power mismatch can be at least less than 0.1 dB.

It should be understood that more than one waveguide 100 may be simultaneously formed, the disclosure is not limited thereto. One waveguide 100 or multiple waveguides 100 may be patterned from the waveguide material layer 106 to form or constitute a part of the optical network. If multiple waveguides 100 are formed, the multiple waveguides 100 may be individual separate waveguides (see FIG. 6) or connected as a single continuous structure (see FIG. 7 through FIG. 10). In addition to or alternatively, the number of the continuous structure, which the multiple waveguides 100 being connected to each other, may be one or more than one, the disclosure is not limited thereto.

Referring to FIG. 7, in some embodiments, a waveguide 10000A is provided, where the waveguide 10000A includes multiple waveguides (e.g., 100A, 100B, and 100C) chained to (e.g., optical coupled to) each other. In FIG. 7, the waveguide 100A may be connected to the waveguide 100B by physically contacting the input port 112 of the waveguide 100B and the output port 132A of the waveguide 100A, and the waveguide 100A may be connected to the waveguide 100B by physically contacting the input port 112 of the waveguide 100C and the output port 132B of the waveguide 100A. By doing so, the input optical signal entering the waveguide 100A can be split into four output optical signals exiting the waveguides 100B and 100C. For example, the configurations of the waveguides 100A through 100C are identical to each other. The configurations of the waveguides 100A through 100C may be the same to the waveguide 100 depicted in FIG. 5 and FIG. 6, where the angles θ1 and θ2 of each of the waveguides 100A through 100C are individually about 90 degrees, and the angle θ3 of each of the waveguides 100A through 100C is about 180 degrees. The elements similar to or substantially the same as the elements described above will use the same reference numbers, and certain details or descriptions of the same elements (e.g., the formations and materials) and the relationship thereof (e.g., the relative positioning configuration and electrical connection) will not be repeated herein. The waveguides 100A, 100B, and 100C may be individually referred to as a waveguide unit of the waveguide 10000A, where the waveguide 100A may be further referred to as an entering waveguide unit of the waveguide 10000A, while the waveguides 100B and 100C may be individually referred to as an exiting waveguide unit of the waveguide 10000A. Alternatively, the waveguide units of the waveguide 10000A may have different configurations, in part or all.

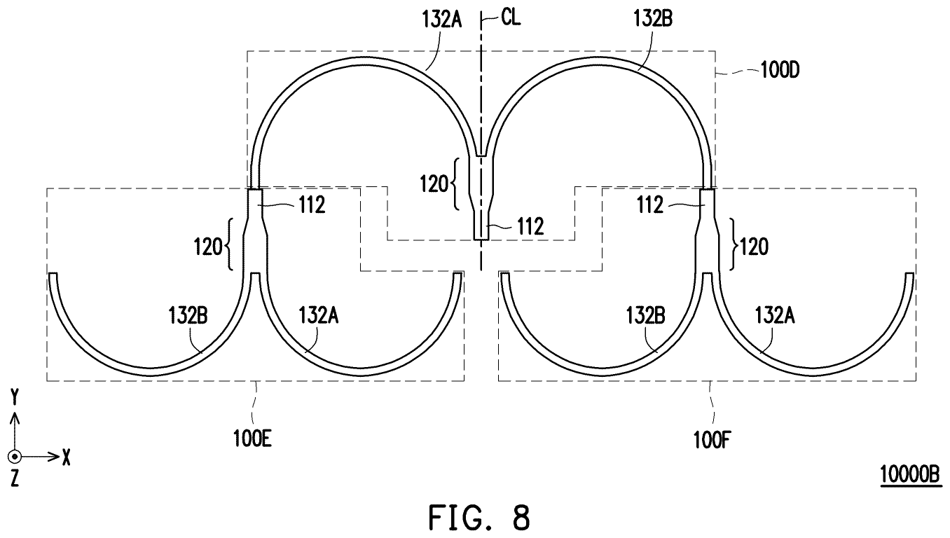

Referring to FIG. 8, in some embodiments, a waveguide 10000B is provided, where the waveguide 10000B includes multiple waveguides (e.g., 100D, 100E, and 100F) chained to (e.g., optical coupled to) each other. In FIG. 8, the waveguide 100D may be connected to the waveguide 100E by physically contacting the input port 112 of the waveguide 100E and the output port 132A of the waveguide 100D, and the waveguide 100D may be connected to the waveguide 100F by physically contacting the input port 112 of the waveguide 100F and the output port 132B of the waveguide 100D. By doing so, the input optical signal entering the waveguide 100D can be split into four output optical signals exiting the waveguides 100E and 100F. For example, the configurations of the waveguides 100D through 100F are identical to each other. The configurations of the waveguides 100D through 100F may be similar to the waveguide 100 depicted in FIG. 5 and FIG. 6, except that the angles θ1 and θ2 of each of the waveguides 100D through 100F are individually about 180 degrees, and the angle θ3 of each of the waveguides 100D through 100F is about 360 degrees, for example. The elements similar to or substantially the same as the elements described above will use the same reference numbers, and certain details or descriptions of the same elements (e.g., the formations and materials) and the relationship thereof (e.g., the relative positioning configuration and electrical connection) will not be repeated herein. The waveguides 100D, 100E, and 100F may be individually referred to as a waveguide unit of the waveguide 10000B, where the waveguide 100D may be further referred to as an entering waveguide unit of the waveguide 10000B, while the waveguides 100E and 100F may be individually referred to as an exiting waveguide unit of the waveguide 10000B. Alternatively, the waveguide units of the waveguide 10000B may have different configurations, in part or all.

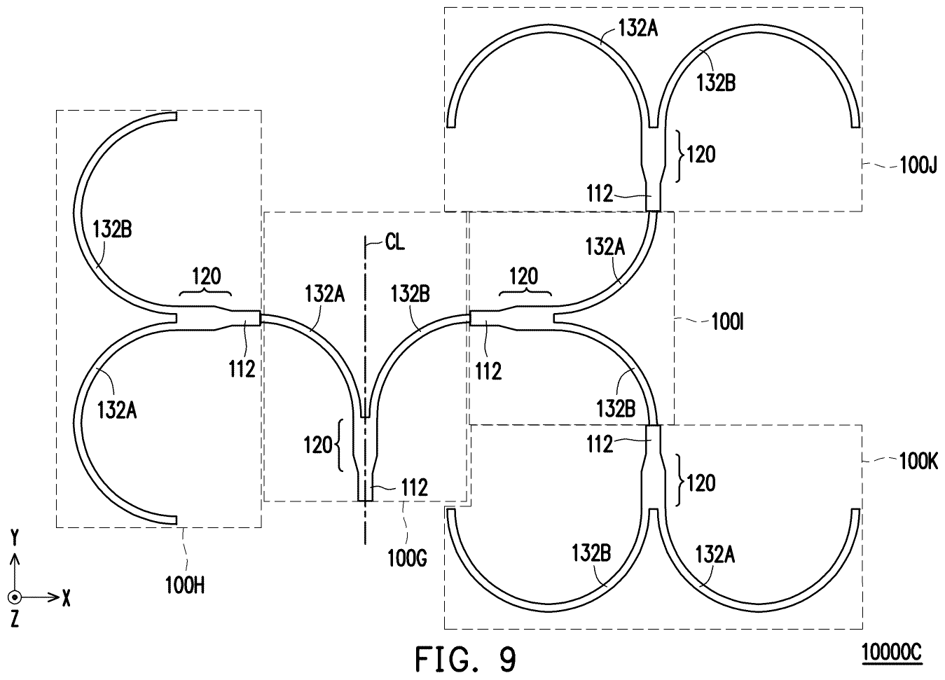

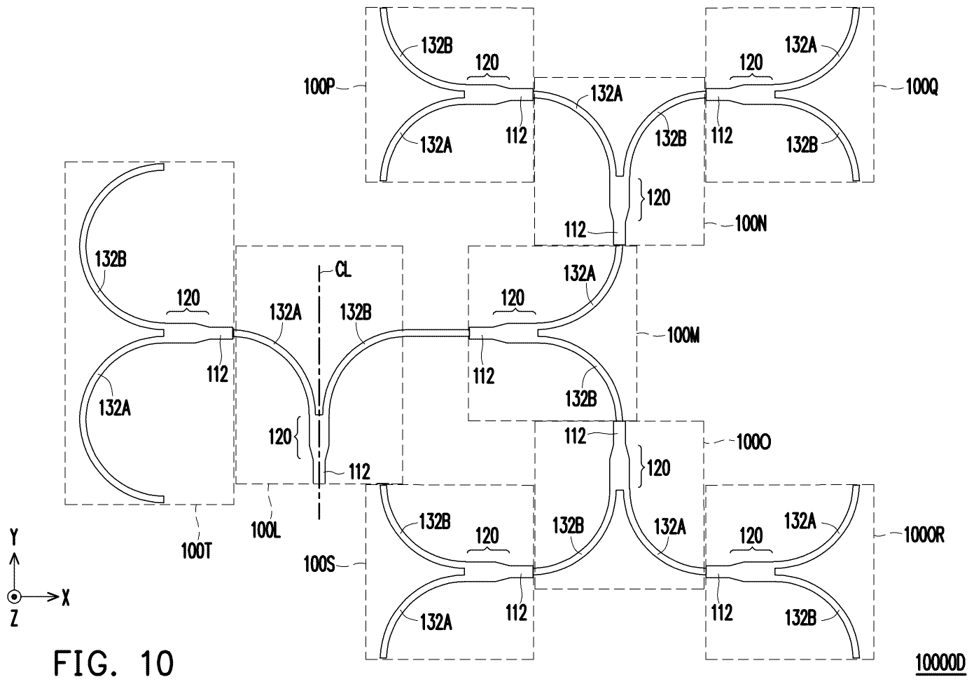

In the above embodiments, the structure of waveguides (e.g., 10000A and 10000B) are symmetric along the central line CL of its own entering waveguide unit. However, the disclosure is not limited thereto; alternatively, the structure of a waveguide can be asymmetric along the central line CL of the entering waveguide unit, see FIG. 9 and FIG. 10.

Referring to FIG. 9, in some embodiments, a waveguide 10000C is provided, where the waveguide 10000C includes multiple waveguides (e.g., 100G, 100H, 100I, 100J and 100K) chained to (e.g., optical coupled to) each other. In FIG. 9, the waveguide 100G may be connected to the waveguide 100H by physically contacting the input port 112 of the waveguide 100H and the output port 132A of the waveguide 100G, and the waveguide 100G may be connected to the waveguide 100I by physically contacting the input port 112 of the waveguide 100I and the output port 132B of the waveguide 100G. On the other hand, the waveguide 100I may be connected to the waveguide 100J by physically contacting the input port 112 of the waveguide 100J and the output port 132A of the waveguide 100I, and the waveguide 100I may be connected to the waveguide 100K by physically contacting the input port 112 of the waveguide 100K and the output port 132B of the waveguide 100I. By doing so, the input optical signal entering the waveguide 100G can be split into six output optical signals exiting the waveguides 100H, 100J and 100K. For example, the configurations of the waveguides 100G and 100I are identical to each other, and the configurations of the waveguides 100H, 100J and 100K are identical to each other, where the configurations of the waveguides 100G and 100I are different from the configurations of the waveguides 100H, 100J and 100K. The configurations of the waveguides 100G and 100I may be the same to the waveguide 100 depicted in FIG. 5 and FIG. 6, where the angles θ1 and θ2 of each of the waveguides 100G and 100I are individually about 90 degrees, and the angle θ3 of each of the waveguides 100G and 100I is about 180 degrees. The configurations of the waveguides 100H, 100J and 100K may be similar to the waveguide 100 depicted in FIG. 5 and FIG. 6, except that the angles θ1 and θ2 of each of the waveguides 100H, 100J and 100K are individually about 180 degrees, and the angle θ3 of each of the waveguides 100H, 100J and 100K is about 360 degrees. The elements similar to or substantially the same as the elements described above will use the same reference numbers, and certain details or descriptions of the same elements (e.g., the formations and materials) and the relationship thereof (e.g., the relative positioning configuration and electrical connection) will not be repeated herein. The waveguides 100G, 100H, 100I, 100J and 100K may be individually referred to as a waveguide unit of the waveguide 10000C, where the waveguide 100G may be further referred to as an entering waveguide unit of the waveguide 10000C, while the waveguides 100H, 100J and 100K may be individually referred to as an exiting waveguide unit of the waveguide 10000C, and the waveguide 100I may be referred to as an internal waveguide unit of the waveguide 10000C. Alternatively, the waveguide units of the waveguide 10000C may all have the substantially identical configurations.

Referring to FIG. 10, in some embodiments, a waveguide 10000D is provided, where the waveguide 10000D includes multiple waveguides (e.g., 100L, 100M, 100N, 1000, 100P, 100Q, 100R, 100S and 100T) chained to (e.g., optical coupled to) each other. In FIG. 10, the waveguide 100L may be connected to the waveguide 100T by physically contacting the input port 112 of the waveguide 100T and the output port 132A of the waveguide 100L, and the waveguide 100L may be connected to the waveguide 100M by physically contacting the input port 112 of the waveguide 100M and the output port 132B of the waveguide 100L, where the waveguide 100M may be connected to the waveguide 100N by physically contacting the input port 112 of the waveguide 100N and the output port 132A of the waveguide 100M, and the waveguide 100M may be connected to the waveguide 1000 by physically contacting the input port 112 of the waveguide 1000 and the output port 132B of the waveguide 100M. On the other hand, the waveguide 100N may be connected to the waveguide 100P by physically contacting the input port 112 of the waveguide 100P and the output port 132A of the waveguide 100N, and the waveguide 100N may be connected to the waveguide 100Q by physically contacting the input port 112 of the waveguide 100Q and the output port 132B of the waveguide 100N, where the waveguide 1000 may be connected to the waveguide 100R by physically contacting the input port 112 of the waveguide 100R and the output port 132A of the waveguide 1000, and the waveguide 1000 may be connected to the waveguide 100S by physically contacting the input port 112 of the waveguide 100S and the output port 132B of the waveguide 1000. By doing so, the input optical signal entering the waveguide 100L can be split into ten output optical signals exiting the waveguides 100L. For example, the configurations of the waveguides 100L, 100M, 100N, 1000, 100P, 100Q, 100R and 100S are identical to each other and different from the configurations of the waveguide 100T. The configurations of the waveguides 100L, 100M, 100N, 1000, 100P, 100Q, 100R and 100S may be the same to the waveguide 100 depicted in FIG. 5 and FIG. 6, where the angles θ1 and θ2 of each of the waveguides 100L, 100M, 100N, 1000, 100P, 100Q, 100R and 100S are individually about 90 degrees, and the angle θ3 of each of the waveguides 100L, 100M, 100N, 1000, 100P, 100Q, 100R and 100S is about 180 degrees. The configurations of the waveguide 100T may be similar to the waveguide 100 depicted in FIG. 5 and FIG. 6, except that the angles θ1 and θ2 of each of the waveguide 100T are individually about 180 degrees, and the angle θ3 of the waveguide 100T is about 360 degrees. The elements similar to or substantially the same as the elements described above will use the same reference numbers, and certain details or descriptions of the same elements (e.g., the formations and materials) and the relationship thereof (e.g., the relative positioning configuration and electrical connection) will not be repeated herein. The waveguides 100L through 100T may be individually referred to as a waveguide unit of the waveguide 10000D, where the waveguide 100L may be further referred to as an entering waveguide unit of the waveguide 10000D, while the waveguides 100P, 100Q, 100R, 100S and 100T may be individually referred to as an exiting waveguide unit of the waveguide 10000D, and the waveguides 100M, 100N and 1000 may be individually referred to as an internal waveguide unit of the waveguide 10000D. Alternatively, the waveguide units of the waveguide 10000D may all have the substantially identical configurations.

In the disclosure, a plurality of waveguide units can be formed in a same material layer and can be individually separate from each other, with different configurations or substantially identical configurations (e.g., in part or all). In addition to or alternatively, a waveguide includes a plurality of waveguide units formed in a same material layer and can be connected to each other, with different configurations or substantially identical configurations (e.g., in part or all). Owing to the waveguides (e.g., 100, 100A to 100T, 10000A to 10000D, or their variations), a compact (fan-out) design of an optical network can be achieved. Other configurations (e.g., the angles θ1 through θ7, etc.) or arrangements of the waveguide in the disclosure are possible.

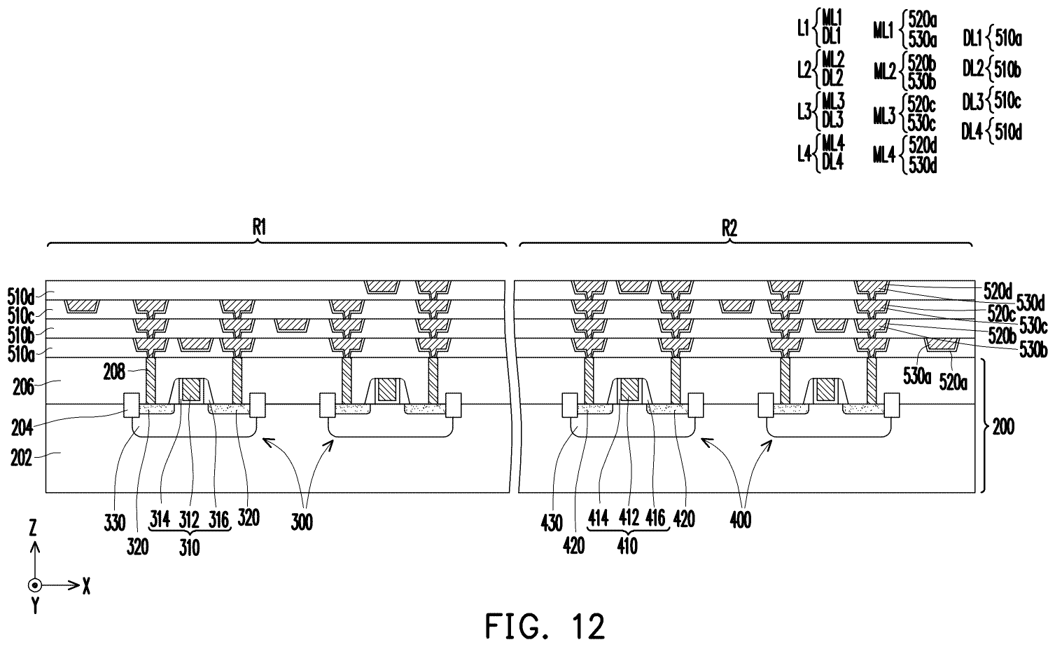

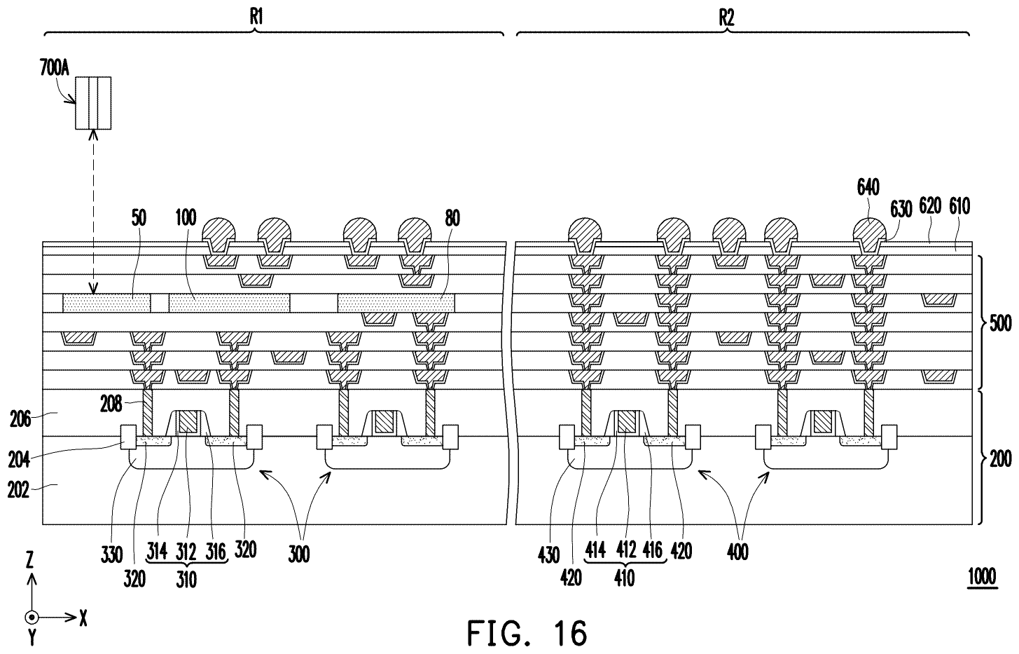

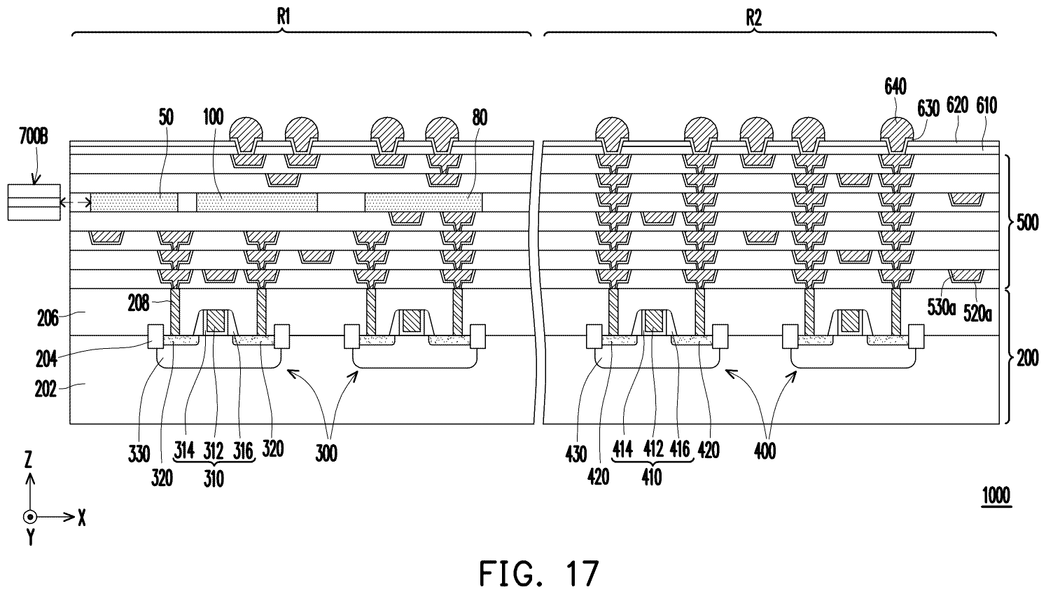

In some embodiments, the waveguide of the disclosure may be adopted in a semiconductor device (e.g., within a photonic integrated die or a photonic integrated component (PIC)). FIG. 12 to FIG. 15 are schematic plane or cross-sectional views of various stages in manufacturing a semiconductor device (e.g., 1000) with a waveguide in accordance with some embodiments of the disclosure. FIG. 16 is a schematic cross-sectional view of a configuration of a semiconductor device (e.g., 1000) and a vertically-mounted external light source (e.g., 700A) in accordance with some embodiments of the disclosure. FIG. 17 is a schematic cross-sectional view of a configuration of a semiconductor device (e.g., 1000) and a horizontally-mounted external light source (e.g., 700B) in accordance with some embodiments of the disclosure.

In some embodiments, the manufacturing method is part of a wafer level packaging process. It is understood that additional processes may be provided before, during, and after the illustrated method, and that some other processes may only be briefly described herein. In the disclosure, it should be appreciated that the illustration of components throughout all figures is schematic and is not in scale. Throughout the various views and illustrative embodiments of the disclosure, the elements similar to or substantially the same as the elements described previously will use the same reference numbers, and certain details or descriptions (e.g., the materials, formation processes, positioning configurations, electrical connections, etc.) of the same elements would not be repeated. For clarity of illustrations, the drawings are illustrated with the orthogonal axes (X, Y and Z) of a Cartesian coordinate system according to which the views are oriented; however, the disclosure is not specifically limited thereto.

Referring to FIG. 12, in some embodiments, an initial structure is provided. For example, the initial structure includes a substrate 200 including a wide variety of devices (also referred to as semiconductor devices) formed in a semiconductor substrate 202 and a stack structure disposed on the substrate 200, as shown in FIG. 12. The devices may include active components, passive components, or a combination thereof. The devices may include integrated circuits devices. The devices may include transistors, capacitors, resistors, diodes, photodiodes, fuse devices, jumpers, inductors, or other similar devices. The functions of the devices may include memory, processors, sensors, amplifiers, power distribution, input/output circuitry, or the like.

In some embodiments, the semiconductor substrate 202 includes a bulk semiconductor substrate, a crystalline silicon substrate, a doped semiconductor substrate (e.g., p-type semiconductor substrate or n-type semiconductor substrate), a semiconductor-on-insulator (SOI) substrate, or the like. In certain embodiments, the semiconductor substrate 202 includes one or more doped regions or various types of doped regions, depending on design requirements. In some embodiments, the doped regions are doped with p-type and/or n-type dopants. For example, the p-type dopants are boron or BF₂ and the n-type dopants are phosphorus or arsenic. The doped regions may be configured for an n-type metal-oxide-semiconductor (NMOS) transistor or a p-type MOS (PMOS) transistor. The semiconductor substrate 202 may be a wafer, such as a silicon wafer. Generally, the SOI substrate is a layer of a semiconductor material formed on an insulator layer. The insulator layer is, for example, a buried oxide (BOX) layer, a silicon oxide layer, or the like. Other substrates, such as a multi-layered or gradient substrate may also be used. In some alternative embodiments, the semiconductor substrate 202 includes a semiconductor substrate made of other suitable elemental semiconductor, such as diamond or germanium; a suitable compound semiconductor, such as gallium arsenide, silicon carbide, gallium phosphide, indium phosphide, indium arsenide and indium antimonide, an alloy semiconductor such as SiGe, GaAsP, AlInAs, AlGaAs, GaInAs, GaInP and GaInAsP or combinations thereof. For example, the semiconductor substrate 202 is a silicon bulk substrate.

As shown in FIG. 12, the devices (such as one or more transistors 300 and one or more transistors 400) may be formed in the semiconductor substrate 202. In some embodiments, a plurality of isolation structures 204 are formed in the semiconductor substrate 202 for separating the transistors 300 and the transistors 400. In certain embodiments, the isolation structures 204 are trench isolation structures. In other embodiments, the isolation structures 204 includes local oxidation of silicon (LOCOS) structures. In some embodiments, the insulator material of the isolation structures 204 includes silicon oxide, silicon nitride, silicon oxynitride, a spin-on dielectric material, or a low-k dielectric material. For example, the low-k dielectric material generally has a dielectric constant lower than 3.9. In one embodiment, the insulator material may be formed by CVD (such as HDP-CVD and SACVD) or formed by spin-on. In certain embodiments, the devices (such as the transistors 300 and the transistors 400) and the isolation structures 204 are formed in the substrate 200 during the front-end-of-line (FEOL) processes. In one embodiment, the transistors 300, 400 are formed following the complementary MOS (CMOS) processes. The number and configurations of the devices formed in the semiconductor substrate 202 should not be limited by the embodiments or drawings of this disclosure. That is, the number of the devices may be more than four. It is understood that the number and configurations of the devices may have different material or configurations depending on product designs.

The transistors 300 and the transistors 400 may be a PMOS transistor. For example, each of the transistors 300 includes a gate structure 310 and source/drain regions 320 located at two opposite sides of the gate structure 310, where the gate structure 310 is formed on an n-well region 330, and the source/drain regions 320 are formed in the n-well region 330. In one embodiment, the gate structure 310 includes a gate electrode 312, a gate dielectric layer 314 and a gate spacer 316. The gate dielectric layer 314 may spread between the gate electrode 312 and the semiconductor substrate 202, and may or may not further cover a sidewall of the gate electrode 312. The gate spacer 316 may laterally surround the gate electrode 312 and the gate dielectric layer 314. In one embodiment, the source/drain regions 320 include doped regions of p-type dopant that are formed in the n-well region 330 by ion implantation. In an alternative embodiment, the source/drain regions 320 include epitaxial structures formed in and protruding from a surface of the semiconductor substrate 202 that are formed by epitaxial growth.

For example, each of the transistors 400 includes a gate structure 410 and source/drain regions 420 located at two opposite sides of the gate structure 410, where the gate structure 410 is formed on an n-well region 430, and the source/drain regions 420 are formed in the n-well region 430. In one embodiment, the gate structure 410 includes a gate electrode 412, a gate dielectric layer 414 and a gate spacer 416. The gate dielectric layer 414 may spread between the gate electrode 412 and the semiconductor substrate 202, and may or may not further cover a sidewall of the gate electrode 412. The gate spacer 416 may laterally surround the gate electrode 412 and the gate dielectric layer 414. In one embodiment, the source/drain regions 420 include doped regions of p-type dopant that are formed in the n-well region 430 by ion implantation. In an alternative embodiment, the source/drain regions 420 include epitaxial structures formed in and protruding from a surface of the semiconductor substrate 202 that are formed by epitaxial growth.

Alternatively, each of the transistors 300 and the transistors 400 may be a NMOS transistor. For example, the transistor 30 includes a gate structure 310 and source/drain regions 320 located at two opposite sides of the gate structure 310, where the gate structure 310 is formed on a p-well region 330, and the source/drain regions 320 are formed in the p-well region 330. In one embodiment, the gate structure 310 includes a gate electrode 312, a gate dielectric layer 314 and a gate spacer 316. The gate dielectric layer 314 may spread between the gate electrode 312 and the semiconductor substrate 202, and may or may not further cover a sidewall of the gate electrode 312. The gate spacer 316 may laterally surround the gate electrode 312 and the gate dielectric layer 314. In one embodiment, the source/drain regions 320 include doped regions of n-type dopant that are formed in the p-well region 330 by ion implantation. In an alternative embodiment, the source/drain regions 320 include epitaxial structures formed in and protruding from a surface of the semiconductor substrate 202 that are formed by epitaxial growth.

For example, each of the transistors 400 includes a gate structure 410 and source/drain regions 420 located at two opposite sides of the gate structure 410, where the gate structure 410 is formed on a p-well region 430, and the source/drain regions 420 are formed in the p-well region 430. In one embodiment, the gate structure 410 includes a gate electrode 412, a gate dielectric layer 414 and a gate spacer 416. The gate dielectric layer 414 may spread between the gate electrode 412 and the semiconductor substrate 202, and may or may not further cover a sidewall of the gate electrode 412. The gate spacer 416 may laterally surround the gate electrode 412 and the gate dielectric layer 414. In one embodiment, the source/drain regions 420 include doped regions of n-type dopant that are formed in the p-well region 430 by ion implantation. In an alternative embodiment, the source/drain regions 420 include epitaxial structures formed in and protruding from a surface of the semiconductor substrate 202 that are formed by epitaxial growth.

In further alternative embodiments, one of the transistors 300 and 400 may have a type being different from the types of the rest of the transistors 300 and 400. The disclosure is not limited thereto. In one non-limiting example, the transistors 300 are PMOS transistors, and the transistors 400 are NMOS transistors; or vice versa.

As illustrated in FIG. 12, for example, the substrate 200 further includes a dielectric layer 206 stacked on the semiconductor substrate 202 and a plurality of contact plugs 208 penetrating through the dielectric layer 206 to electrically connect to the transistors 300 and 400. In certain embodiments, the dielectric layer 206 and the contact plugs 208 are also formed in the structure 200 during the FEOL processes. The dielectric layer 206 may laterally surround the gate structures 310 and 410 and cover the source/drain regions 320 and 420 for providing protections to the devices formed in/on the semiconductor substrate 202. Some of the contact plugs 208 may penetrate through the dielectric layer 206 in order to establish electrical connection with the source/drain regions 320 and 420, while others of the contact plugs 208 (not shown) may penetrate through the dielectric layer 206 to establish electrical connection with the gate electrodes (e.g. the gate electrodes 312, 412) of the gate structures 310 and 410, in order to provide terminals for electrical connections to later-formed components (e.g. an interconnect or interconnect structure) or external components.

The dielectric layer 206 may be referred to as an interlayer dielectric (ILD) layer, while the contact plugs 208 may be referred to as metal contacts or metallic contacts. For example, the contact plugs 208 electrically connected to the source/drain regions 320, 420 are referred to as source/drain contacts, and the contact plugs 208 electrically connected to the gate electrodes 312, 412 are referred to as gate contacts. In some embodiments, the contact plugs 208 may include copper (Cu), copper alloys, nickel (Ni), aluminum (Al), manganese (Mn), magnesium (Mg), silver (Ag), gold (Au), tungsten (W), a combination of thereof, or the like. The contact plugs 208 may be formed by, for example, plating such as electroplating or electroless plating, CVD such as PECVD, ALD, and PVD, a combination thereof, or the like. Throughout the description, the term “copper” is intended to include substantially pure elemental copper, copper containing unavoidable impurities, and copper alloys containing minor amounts of elements such as tantalum, indium, tin, zinc, manganese, chromium, titanium, germanium, strontium, platinum, magnesium, aluminum or zirconium, etc.

In some embodiments, the dielectric layer 206 includes silicon oxide, silicon nitride, silicon carbide, silicon oxynitride, silicon carbonitride, silicon carbide oxynitride, spin-on glass (SOG), phosphosilicate glass (PSG), borosilicate glass (BSG), borophosphosilicate glass (BPSG), fluorinated silica glass (FSG), carbon doped silicon oxide (e.g., SiCOH), polyimide, and/or a combination thereof. In alternative embodiments, the dielectric layer 206 include low-k dielectric materials. For example, the low-k dielectric material generally has a dielectric constant lower than 3.9. Examples of low-k dielectric materials may include BLACK DIAMOND® (Applied Materials of Santa Clara, Calif.), Xerogel, Aerogel, amorphous fluorinated carbon, Parylene, BCB, Flare, SILK® (Dow Chemical, Midland, Mich.), hydrogen silsesquioxane (HSQ) or fluorinated silicon oxide (SiOF), and/or a combination thereof. It is understood that the dielectric layer 206 may include one or more dielectric materials. For example, the dielectric layer 206 include a single-layer structure or a multilayer structure. In some embodiments, the dielectric layer 206 is formed to a suitable thickness by CVD such as flowable chemical vapor deposition (FCVD), HDP-CVD, and SACVD, spin-on, sputtering, or other suitable methods.

A seed layer (not shown) may be optionally formed between the dielectric layer 206 and the contact plugs 208. That is, for example, the seed layer covers a bottom surface and sidewalls of each of the contact plugs 208. In some embodiments, the seed layer is a metal layer, which may be a single layer or a composite layer comprising a plurality of sub-layers formed of different materials. In some embodiments, the seed layer includes copper layer and the seed layer includes a titanium layer and a copper layer over the titanium layer. The seed layer is formed using, for example, PVD or the like. In one embodiment, the seed layer may be omitted.

In addition, an additional barrier layer or adhesive layer (not shown) may be optionally formed between the contact plugs 208 and the dielectric layer 206. Owing to the additional barrier layer or adhesive layer, it is able to prevent the seed layer and/or the contact plugs 208 from diffusing to the underlying layers and/or the surrounding layers. The additional barrier layer or adhesive layer may include Ti, TiN, Ta, TaN, a combination thereof, a multilayer thereof, or the like, and may be formed using CVD, ALD, PVD, a combination thereof, or the like. In an alternative embodiment of which the seed layer is included, the additional barrier layer or adhesive layer is interposed between the dielectric layer 206 and the seed layer, and the seed layer is interposed between the contact plugs 208 and the additional barrier layer or adhesive layer. In one embodiment, the additional barrier layer or adhesive layer may be omitted.

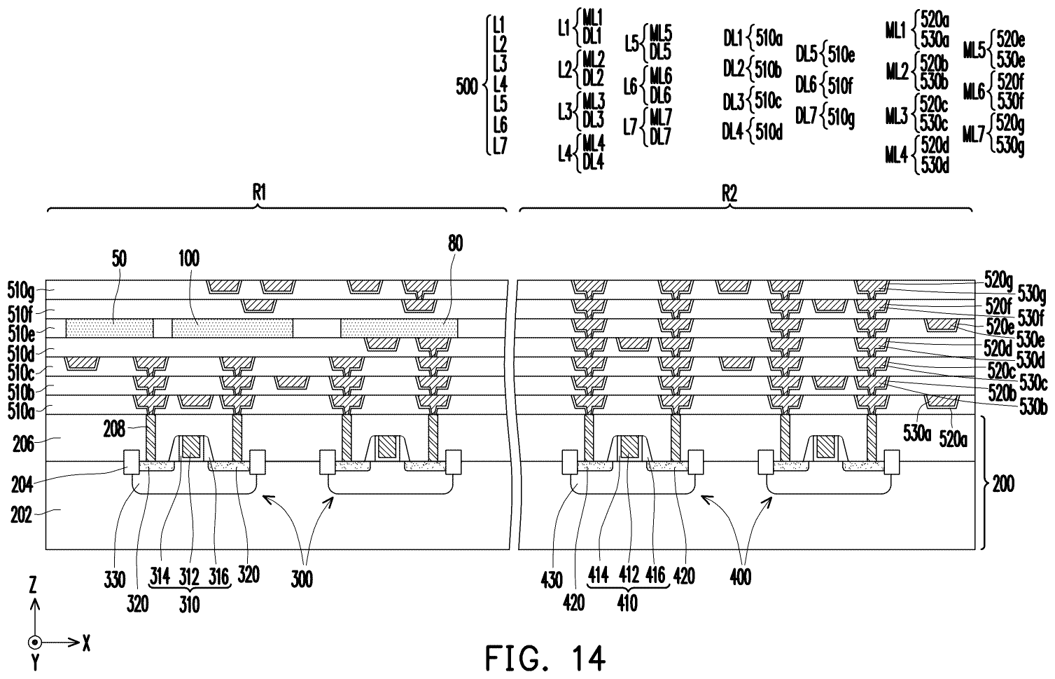

In some embodiments, the stacked structure is formed on the substrate 200. For example, as show in FIG. 12, the stacked structure includes a plurality of build-up layers L1, L2, L3, and L4 of an interconnect 500 (depicted in FIG. 14) stacked thereon. In some embodiments, the build-up layer L1 is disposed on (e.g., in physical contact with) and electrically coupled to the devices such as the transistors 300 and 400 through the contact plugs 208 for providing routing function thereto. In the case, the build-up layer L2 is disposed on (e.g., in physical contact with) and electrically connected to the build-up layer L1, and thus is electrically coupled to the devices such as the transistors 300 and 400 through the contact plugs 208 and the build-up layer L1 for providing routing function thereto. The build-up layer L3 is disposed on (e.g., in physical contact with) and electrically connected to the build-up layer L2, and thus is electrically coupled to the devices such as the transistors 300 and 400 through the contact plugs 208 and the build-up layers L1-L2 for providing routing function thereto. The build-up layer L4 is disposed on (e.g., in physical contact with) and electrically connected to the build-up layer L3, and thus is electrically coupled to the devices such as the transistors 300 and 400 through the contact plugs 208 and the build-up layers L1-L3 for providing routing function thereto.

For example, as shown in FIG. 12, the build-up layer L1 is sandwiched between the semiconductor substrate 202 and the build-up layer L2, the build-up layer L2 is sandwiched between the build-up layer L1 and the build-up layer L3, and the build-up layer L3 is sandwiched between the build-up layer L2 and the build-up layer L4. The build-up layers L1 through L4 are electrically coupled to each other. The build-up layers L1-L4 may be referred to as a first build-up layer L1, a second build-up layer L2, a third build-up layer L3, and a fourth build-up layer L4, respectively.

The formation of the build-up layer L1 of the stacked structure may include, but not limited to, forming a blanket layer of a dielectric material (not shown) over the substrate 200 to cover up the devices such as the transistors 300 and 400; patterning the dielectric material blanket layer to form a dielectric layer 510a, where a plurality of first openings (not label) penetrate through the dielectric layer 510a; forming a seed layer 520a in the first openings; and forming a conductive material in the opening over the seed layer 520a to form a conductive layer 530a over the seed layer 520a so to form a metallization layer ML1 in the first openings formed in the dielectric layer 510a, thereby forming the build-up layer L1. For example, as shown in FIG. 12, the metallization layer ML1 of the build-up layer L1 includes the seed layer 520a and the conductive layer 530a standing thereon and electrically connected thereto, and is laterally covered by a dielectric structure DL1 of the build-up layer L1, where the dielectric structure DL1 includes the dielectric layer 510a. As shown in FIG. 12, for example, the conductive layer 530a is electrically connected to the transistors 300 and 400 through the seed layer 520a and the conductive plugs 208.

In some embodiments, the material of the dielectric layer 510a may be polyimide (PI), PBO, BCB, a nitride such as silicon nitride, an oxide such as silicon oxide, PSG, BSG, BPSG, a combination thereof, or the like, which may be patterned using a photolithography and/or etching process. The etching process may include a dry etching, a wet etching, or a combination thereof. After the etching process, a cleaning step may be optionally performed, for example to clean and remove the residue generated from the etching process. In some embodiments, the dielectric material blanket layer is formed by suitable fabrication techniques such as spin-on coating, CVD (e.g., PECVD), or the like. For example, the material of the dielectric layer 510a is silicon oxide. The first openings formed in the dielectric layer 510a each may include a trench hole and a via hole underlying and spatially communicated to the trench hole. In some embodiments, the first openings each include a dual damascene structure. The formation of the first openings is not limited to the disclosure. The formation of first openings (with the dual damascene structure) can be formed by any suitable forming process, such as a via first approach or a trench first approach.

A lateral size of the trench holes may be greater than a lateral size of the via holes. In some embodiments, a sidewall of each of the via holes is a slant sidewall. In alternative embodiments, the sidewall of each of the via holes OV1 is a vertical sidewall. In some embodiments, a sidewall of each of the trench holes is a vertical sidewall. In alternative embodiments, the sidewall of each of the trench holes is a slant sidewall. The sidewall of one via hole and the sidewall of a respective one trench hole may be collectively referred to as a sidewall of one opening formed in the dielectric layer 510a. For illustrative purposes, the number of the first openings does not limit the disclosure, and may be designated and selected based on the demand and layout design. Portions of the metallization layer ML1 formed in the trench holes may be referred to as conductive traces or conductive wires horizontally extended (e.g., extending in a direction X and/or a direction Y), and portions of the metallization layer ML1 formed in the via holes may be referred to as conductive vias vertically extended (e.g., extending in a direction Z).

In other embodiments, the dielectric material blanket layer includes two-layer structure, where a first dielectric layer includes a silicon carbide (SiC) layer, a silicon nitride (Si₃N₄) layer, an aluminum oxide layer, or the like, and the second dielectric layer (stacking on the first dielectric layer) includes a silicon oxide layer (e.g., a silicon-rich oxide (SRO) layer), a silicon nitride layer, a silicon oxynitride layer, a spin-on dielectric layer, or a low-k dielectric layer. It should be noted that the low-k dielectric layer is generally made of dielectric materials having a dielectric constant lower than 3.9. In some alternative embodiments, the first dielectric layer and the second dielectric layer have different etching selectivities. In the case, the first dielectric layer may be referred to as an etching stop layer (ESL) to prevent the underlying elements (e.g., the contact plugs 208 and the dielectric layer 206) from damage caused by the over-etching, while the second dielectric layer may be referred to as an inter-metallic layer (IML). In such alternative embodiments, the first dielectric layer and the second dielectric layer are patterned through a set(s) of photolithography and etching processes. The etching process may include a dry etching, a wet etching, or a combination thereof. After the etching process, a cleaning step may be optionally performed, for example to clean and remove the residue generated from the etching process. However, the disclosure is not limited thereto, and the etching process may be performed through any other suitable method. The first openings formed in the first dielectric layer and the second dielectric layer each may include a trench hole and a via hole underlying and spatially communicated to the trench hole. For example, the trench holes are formed in the second dielectric layer and extend from an illustrated top surface of the second dielectric layer to a position inside the second dielectric layer. For example, the via holes are formed in the second dielectric layer and the first dielectric layer and extend from the position inside the second dielectric layer to an illustrated bottom surface of the first dielectric layer. The position may be about ½ to about ⅓ of a thickness of the second dielectric layer; however, the disclosure is not limited thereto.

In some embodiments, the seed layer 520a and the conductive layer 530a are sequentially formed in the first openings by, but not limited to, conformally forming a blanket layer made of metal or metal alloy materials over the dielectric structure DL1 and extending into the first openings, so to line the sidewalls of the first openings; filling the conductive material in the first openings; and removing excess amount of the blanket layer made of metal or metal alloy materials and the conductive material over the illustrated top surface of the dielectric layer 510a, thereby the metallization layer ML1 including the seed layer 520a and the conductive layer 530a is manufactured. The removal may be performed by a planarizing process such as a mechanical grinding, a chemical mechanical polishing (CMP), and/or an etching process. After the planarizing process, a cleaning process may be optionally performed, for example to clean and remove the residue generated from the planarizing process. However, the disclosure is not limited thereto, and the planarizing process may be performed through any other suitable method.

In some embodiments, the seed layer 520a is referred to as a metal layer, which can be a single layer or a composite layer including a plurality of sub-layers formed of different materials. In some embodiments, the seed layer 520a includes titanium, copper, molybdenum, tungsten, titanium nitride, titanium tungsten, combinations thereof, or the like. For example, the seed layer 520a may include a titanium layer and a copper layer over the titanium layer. The seed layer520a may be formed using, for example, sputtering, PVD, or the like. The seed layer 520a may have a thickness (as measured in the direction Z) of about 1 nm to about 50 nm, although other suitable thickness may alternatively be utilized.

In some embodiments, a material of the conductive material includes a suitable conductive material, such as metal and/or metal alloy. For example, the conductive material can be Al, aluminum alloys, Cu, copper alloys, or combinations thereof (e.g., AlCu), the like, or combinations thereof. In some embodiments, the conductive material is formed by plating process or any other suitable method, which the plating process may include electroplating or electroless plating, or the like. In alternative embodiments, the conductive material may be formed by deposition. The disclosure is not limited thereto. In the case, an illustrated top surface of the metallization layer ML1 is substantially level with an illustrated top surface of the dielectric structure DL1. That is, the illustrated top surface of the metallization layer ML1 is substantially coplanar to the illustrated top surface of the dielectric structure DL1.

The formation, material, and configuration of components of each of the build-up layer L2, the build-up layer L3, and the build-up layer L4 are similar to or substantially identical to the forming process, material, and configuration of the components of the build-up layer L1 as aforementioned above, and thus are not repeated herein for brevity.

Continued on FIG. 12, for example, the build-up layer L2 includes a dielectric structure DL2 and a metallization layer ML2 disposed therein. The dielectric structure DL2 may include a dielectric layer 510b, where the dielectric structure DL2 may be penetrated by a plurality of second openings. In the case, the metallization layer ML2 is disposed inside the second openings, where the metallization layer ML2 includes a seed layer 520b and a conductive layer 530b disposed thereon, the seed layer 520b lines sidewalls of the second openings, and the conductive layer 530b directly stacked on the seed layer 520b and fills the second openings. The conductive layer 530b of the metallization layer ML2 is electrically coupled to the conductive layer 530a of the metallization layer ML1 through the seed layer 520b, for example, as shown in FIG. 12. The second openings each may include a trench hole and a via hole underlying and spatially communicated to the trench hole. As illustrated in FIG. 12, portions of the metallization layer ML2 formed in the trench holes may be referred to as conductive traces or conductive wires horizontally extended (e.g., extending in the direction X and/or the direction Y), and portions of the metallization layer ML2 formed in the via holes may be referred to as conductive vias vertically extended (e.g., extending in the direction Z). In the case, an illustrated top surface of the metallization layer ML2 is substantially level with an illustrated top surface of the dielectric structure DL2. That is, the illustrated top surface of the metallization layer ML2 is substantially coplanar to the illustrated top surface of the dielectric structure DL2.

In some embodiments, the build-up layer L3 includes a dielectric structure DL3 and a metallization layer ML3 disposed therein. The dielectric structure DL3 may include a dielectric layer 510c, where the dielectric structure DL3 may be penetrated by a plurality of third openings. In the case, the metallization layer ML3 is disposed inside the third openings, where the metallization layer ML3 includes a seed layer 520c and a conductive layer 530c disposed thereon, the seed layer 520c lines sidewalls of the third openings, and the conductive layer 530c directly stacked on the seed layer 520c and fills the third openings. The conductive layer 530c of the metallization layer ML3 is electrically coupled to the conductive layer 530b of the metallization layer ML2 through the seed layer 520c, for example, as shown in FIG. 12. The third openings each may include a trench hole and a via hole underlying and spatially communicated to the trench hole. As illustrated in FIG. 12, portions of the metallization layer ML3 formed in the trench holes may be referred to as conductive traces or conductive wires horizontally extended (e.g., extending in the direction X and/or the direction Y), and portions of the metallization layer ML3 formed in the via holes may be referred to as conductive vias vertically extended (e.g., extending in the direction Z). In the case, an illustrated top surface of the metallization layer ML3 is substantially level with an illustrated top surface of the dielectric structure DL3. That is, the illustrated top surface of the metallization layer ML3 is substantially coplanar to the illustrated top surface of the dielectric structure DL3.

In some embodiments, the build-up layer L4 includes a dielectric structure DL4 and a metallization layer ML4 disposed therein. The dielectric structure DL4 may include a dielectric layer 520d, where the dielectric structure DL4 may be penetrated by a plurality of fourth opening. In the case, the metallization layer ML4 is disposed inside the fourth openings, where the metallization layer ML4 includes a seed layer 520d and a conductive layer 530d disposed thereon, the seed layer 520d lines sidewalls of the fourth openings, and the conductive layer 530d directly stacked on the seed layer 520d. The conductive layer 530d of the metallization layer ML4 is electrically coupled to the conductive layer 530c of the metallization layer ML3 through the seed layer 520d, for example, as shown in FIG. 12. The fourth openings each may include a trench hole and a via hole underlying and spatially communicated to the trench hole. As illustrated in FIG. 12, portions of the metallization layer ML4 formed in the trench holes may be referred to as conductive traces or conductive wires horizontally extended (e.g., extending in the direction X and/or the direction Y), and portions of the metallization layer ML4 formed in the via holes may be referred to as conductive vias vertically extended (e.g., extending in the direction Z). In the case, an illustrated top surface of the metallization layer ML4 is substantially level with an illustrated top surface of the dielectric structure DL4. That is, the illustrated top surface of the metallization layer ML4 is substantially coplanar to the illustrated top surface of the dielectric structure DL4. In addition, the build-up layers L1, L2, L3, and L4 may be referred to as redistribution layers or routing layers of the interconnect 500 (in FIG. 14).

In some embodiments, the initial structure provided in FIG. 12 includes several regions, such as a region R1 (may be referred to as a photonic circuitry region for a photonic integrated die or a PIC), a region R2 (may be referred to as an electrical circuitry region for an electrical integrated die or an electrical integrated component (EIC)), and other region(s) (such as a peripheral region for a seal-ring structure or the like; not shown) (if any). For example, the region R1 is laterally next to the region R2, as shown in FIG. 12. The other region(s) such a peripheral region may surround the regions R1 and R2. The disclosure is not limited thereto.

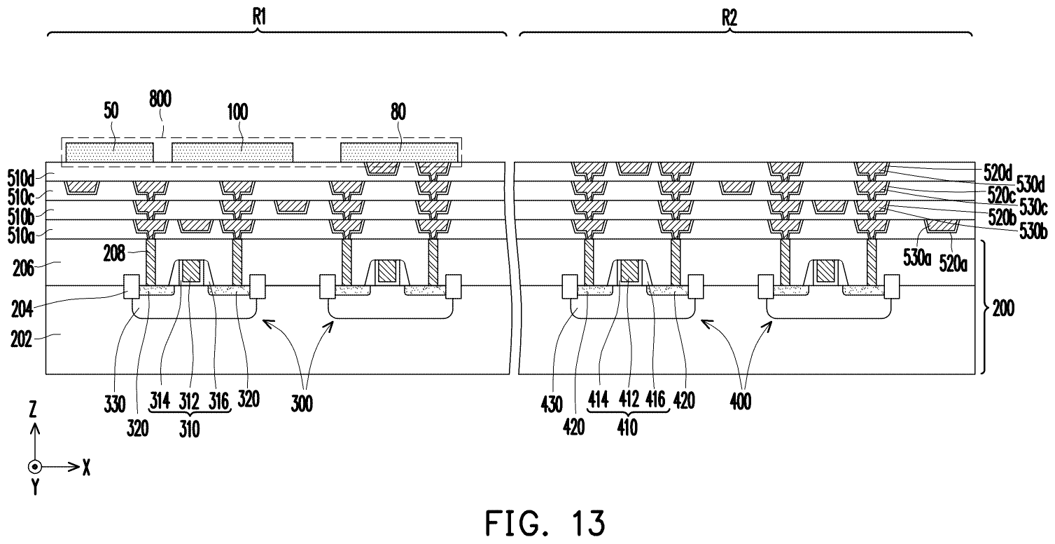

Referring to FIG. 13, in some embodiments, at least one waveguide 100 is formed over the build-up layer L4 within the region R1. Only one waveguide 100 is shown in FIG. 13 for easy illustration and simplicity, the number of the waveguide 100 may be selected and designated based on the demand and design requirement, and is not limited in the disclosure. The details, formation and material of the waveguide 100 in the disclosure have been previously discussed in FIG. 1 through FIG. 6 in conjunction with FIG. 11, and thus are not repeated herein. In addition to or alternatively, the at least one waveguide may include one or more waveguides selected from a group of the waveguides previously discussed (e.g., 100, 10000A, 10000B, 10000C 10000D, or their variations), the disclosure is not limited thereto.

During the formation of the waveguide 100, at least one coupler 50 and at least one photonic component 80 are also formed over the build-up layer L4 within the region R1. Only one coupler 50 and only one photonic component 80 are shown in FIG. 13 for easy illustration and simplicity, the number of the coupler 50 and the number of the photonic component 80 independently may be selected and designated based on the demand and design requirement, and is not limited in the disclosure. In some cases, the waveguide 100, the photonic component 80, and the coupler 50 may be collectively referred to as a photonic layer 800 with an optical network. In some embodiments, the waveguide 100, the coupler 50 and the photonic component 80 are optically coupled to each other. The coupler 50 is considered as an optical device or photonic component of the disclosure. It is appreciated that the photonic component 80 may also referred to as an optical device of the disclosure.

In some embodiments, the waveguide 100 is disposed between and spacing apart from the coupler 50 and the photonic component 80, in the plane view (e.g., the X-Y plane) along the direction Z; in such case, a dielectric material (e.g., forming the dielectric layer 510a of a build-up layer (e.g., L5)) disposed between any two of the coupler 50, the photonic component 80 and the waveguide 100 being physically separated from one another needs to be optically transparent to the to-be-transmitted light. Alternatively, the photonic component 80 may be integrated with the waveguide 100, where the waveguide 100 may be disposed between the coupler 50 and the photonic component 80, distant from the coupler 50 and in direct contact with the photonic component 80, in the plane view (e.g., the X-Y plane) along the direction Z. Or alternatively, the coupler 50 may be integrated with the waveguide 100, where the waveguide 100 may be disposed between the coupler 50 and the photonic component 80, distant from the photonic component 80 and in direct contact with the coupler 50, in the plane view (e.g., the X-Y plane) along the direction Z. Or, the coupler 50 and the photonic component 80 may be integrated with the waveguide 100, where the waveguide 100 may be disposed between and in direct contact with the coupler 50 and the photonic component 80, in the plane view (e.g., the X-Y plane) along the direction Z. The disclosure is not specifically limited thereto.

The coupler 50 may be or include a grating coupler, an edge coupler, or a coupler combining the functionalities of the grating coupler and the edge coupler. In some embodiments, the coupler 50 is positioned at a light path between from an external light source (such as an optical fiber coupled to another PIC or the like) and the waveguide 100, which is configured to optically couple a light emitting from the external light source to the waveguide 100 or optically couple a light transmitted along the waveguide 100 to the external light source.

In embodiments of which the coupler 50 is or includes the grating coupler, in order to direct light to a certain direction, widths of a plurality of discrete trenches (not shown) formed in the coupler 50 (e.g., at an illustrated top surface thereof) may vary along a light transmission direction. For instance, the coupler 50 directs light toward the waveguide 100 optically coupled thereto, where the waveguide 100 is located at a left-hand side of the coupler 50, as shown in FIG. 14. The widths of the trenches in the coupler 50 may gradually decrease toward the left end of the coupler 50 to the right end of the coupler 50, in a cross-section view along the direction Z. As another example, another coupler 50 (not shown) may direct light toward a waveguide 100 (not shown) optically coupled thereto, where the waveguide 100 may be located at a right-hand side of the another coupler 50. In such case, the widths of the trenches in the another coupler 50 may gradually decrease toward the right end of the another coupler 50 to the left end of the another coupler 50, in a cross-section view along the direction Z. It is appreciated that one of ordinary skills in the art understood that the trenches formed in the grating coupler have an extending direction substantially perpendicular to a direction of directing the light. The coupler 50 may be a photonic structure that allows an optical signal and/or an optical power to be transferred between the waveguide and the external light source such as a vertically-mounted optical fiber (e.g., 700A shown in FIG. 16) or a waveguide of another photonic system or PIC disposed vertically.

Alternatively, the coupler 50 is or includes the edge coupler. The coupler 50 may be a photonic structure that allows an optical signal and/or an optical power to be transferred between the waveguide and the external light source such as a horizontally-mounted optical fiber (e.g., 700B shown in FIG. 17) or a waveguide of another photonic system or PIC disposed laterally. These and other photonic structures are considered within the scope of the disclosure. Or alternatively, the coupler 50 is or includes the grating coupler and the edge coupler. The coupler 50 may be a photonic structure that allows an optical signal and/or an optical power to be transferred between the waveguide and the external light sources such as the vertically-mounted optical fiber (e.g., 700A shown in FIG. 16) or a waveguide of another photonic system or PIC disposed vertically, and the horizontally-mounted optical fiber (e.g., 700B shown in FIG. 17) or a waveguide of another photonic system or PIC disposed laterally. These and other photonic structures are considered within the scope of the disclosure.

The photonic component 80 may be or include at least one photodetector and/or at least one modulator. The photodetector may be optically coupled to the waveguide 100 to detect an optical signal from the waveguide 100 and generate an electrical signal corresponding to the optical signal. A modulator may be optically coupled to the waveguide 100 to receive an electrical signal and generate a corresponding optical signal by modulating an optical power. Optical power may be provided to the waveguides 100 by a light source (not shown). In this manner, the photonic component 80 facilitates the input/output (I/O) of optical signals to and from the waveguides 100. In addition to or alternatively, the photonic component 80 may include other active or passive components, such as light sources (as such laser diodes, lamps, other light emitting diodes, or the like), optical signal waveguides without a functionality of splitting signals, filters, reflectors, converters, switches, other types of photonic structures or devices, or the combination thereof. The disclosure is not limited thereto.

In some embodiments, the metallization layer ML4 underneath the photonic component 80 are connected to the photonic component 80, as shown in FIG. 13. For example, the metallization layer ML4 underneath the photonic component 80 are in physical contact with and electrically coupled to the photonic component 80. The metallization layer ML4 electrically coupled to the photonic component 80 allow an electrical power or an electrical signal to be transmitted to the photonic component 80 and an electrical signal to be transmitted from the photonic component 80. In this manner, the photonic component 80 may convert electrical signals into optical signals transmitted by the waveguides 100, and/or may convert optical signals from the waveguides 100 into electrical signals transmitting to the devices (e.g., the transistor 300) formed in the substrate 200 within the region R1, where the transistor 300 may function as a driver to control the photonic component 80.

Referring to FIG. 14, in some embodiments, a plurality of build-up layers L5, L6, and L7 of the interconnect 500 (depicted in FIG. 14) are formed over the build-up layer L4. In some embodiments, the build-up layer L5 is disposed on (e.g., in physical contact with) and electrically coupled to the build-up layer L4, and thus is electrically coupled to the devices formed in the substrate 200 through the contact plugs 208 and the build-up layers L1-L4 for providing routing function thereto. In the case, the build-up layer L6 is disposed on (e.g., in physical contact with) and electrically connected to the build-up layer L5, and thus is electrically coupled to the devices formed in the substrate 200 through the contact plugs 208 and the build-up layers L1-L5 for providing routing function thereto. The build-up layer L7 is disposed on (e.g., in physical contact with) and electrically connected to the build-up layer L6, and thus is electrically coupled to the devices formed in the substrate 200 through the contact plugs 208 and the build-up layers L1-L6 for providing routing function thereto.

For example, as shown in FIG. 14, the build-up layer L5 is sandwiched between the build-up layer L4 and the build-up layer L6, and the build-up layer L6 is sandwiched between the build-up layer L5 and the build-up layer L7. The build-up layers L5 through L7 are electrically coupled to each other, in some embodiments. The build-up layers L5-L7 may be referred to as a fifth build-up layer L5, a sixth build-up layer L6, and a seventh build-up layer L7, respectively. For example, the build-up layers L1 through L8 are electrically coupled to each other. The formation, material, and configuration of components of each of the build-up layer L5, the build-up layer L6, and the build-up layer L7 are similar to or substantially identical to the forming process, material, and configuration of the components of the build-up layer L1 as aforementioned above in FIG. 12, and thus are not repeated herein for brevity.

Continued on FIG. 14, for example, the build-up layer L5 includes a dielectric structure DL5 and a metallization layer ML5 disposed therein. The dielectric structure DL5 may include a dielectric layer 510e, where the dielectric structure DL5 may be penetrated by a plurality of fifth openings. In the case, the metallization layer ML5 is disposed inside the fifth openings, where the metallization layer ML5 includes a seed layer 520e and a conductive layer 530e disposed thereon, the seed layer 520e lines sidewalls of the fifth openings, and the conductive layer 530e directly stacked on the seed layer 520e and fills the fifth openings. The conductive layer 530e of the metallization layer ML5 is electrically coupled to the conductive layer 530d of the metallization layer ML4 through the seed layer 520e, for example, as shown in FIG. 14. The fifth openings each may include a trench hole and a via hole underlying and spatially communicated to the trench hole. As illustrated in FIG. 14, portions of the metallization layer ML5 formed in the trench holes may be referred to as conductive traces or conductive wires horizontally extended (e.g., extending in the direction X and/or the direction Y), and portions of the metallization layer ML5 formed in the via holes may be referred to as conductive vias vertically extended (e.g., extending in the direction Z). In the case, an illustrated top surface of the metallization layer ML5 is substantially level with an illustrated top surface of the dielectric structure DL5. That is, the illustrated top surface of the metallization layer ML5 is substantially coplanar to the illustrated top surface of the dielectric structure DL5.

In some embodiments, the build-up layer L6 includes a dielectric structure DL6 and a metallization layer ML6 disposed therein. The dielectric structure DL6 may include a dielectric layer 510f, where the dielectric structure DL6 may be penetrated by a plurality of sixth openings. In the case, the metallization layer ML6 is disposed inside the sixth openings, where the metallization layer ML6 includes a seed layer 520f and a conductive layer 530f disposed thereon, the seed layer 520f lines sidewalls of the sixth openings, and the conductive layer 530f directly stacked on the seed layer 520f and fills the sixth openings. The conductive layer 530f of the metallization layer ML6 is electrically coupled to the conductive layer 530e of the metallization layer ML5 through the seed layer 520f, for example, as shown in FIG. 14. The sixth openings each may include a trench hole and a via hole underlying and spatially communicated to the trench hole. As illustrated in FIG. 14, portions of the metallization layer ML6 formed in the trench holes may be referred to as conductive traces or conductive wires horizontally extended (e.g., extending in the direction X and/or the direction Y), and portions of the metallization layer ML6 formed in the via holes may be referred to as conductive vias vertically extended (e.g., extending in the direction Z). In the case, an illustrated top surface of the metallization layer ML6 is substantially level with an illustrated top surface of the dielectric structure DL6. That is, the illustrated top surface of the metallization layer ML6 is substantially coplanar to the illustrated top surface of the dielectric structure DL6.

In some embodiments, the build-up layer L7 includes a dielectric structure DL7 and a metallization layer ML7 disposed therein. The dielectric structure DL7 may include a dielectric layer 510g, where the dielectric structure DL7 may be penetrated by a plurality of seventh openings. In the case, the metallization layer ML7 is disposed inside the seventh openings, where the metallization layer ML7 includes a seed layer 520g and a conductive layer 530g disposed thereon, the seed layer 520g lines sidewalls of the seventh openings, and the conductive layer 530g directly stacked on the seed layer 520g and fills the seventh openings. The conductive layer 530g of the metallization layer ML7 is electrically coupled to the conductive layer 530f of the metallization layer ML6 through the seed layer 520g, for example, as shown in FIG. 14. The seventh openings each may include a trench hole and a via hole underlying and spatially communicated to the trench hole. As illustrated in FIG. 14, portions of the metallization layer ML7 formed in the trench holes may be referred to as conductive traces or conductive wires horizontally extended (e.g., extending in the direction X and/or the direction Y), and portions of the metallization layer ML7 formed in the via holes may be referred to as conductive vias vertically extended (e.g., extending in the direction Z). In the case, an illustrated top surface of the metallization layer ML7 is substantially level with an illustrated top surface of the dielectric structure DL7. That is, the illustrated top surface of the metallization layer ML7 is substantially coplanar to the illustrated top surface of the dielectric structure DL7. In addition, the build-up layers L5, L6, and L7 may be referred to as redistribution layers or routing layers of the interconnect 500 (in FIG. 14).

In some embodiments, as shown in FIG. 14, the photonic layer 800 including the waveguide 100, the photonic component 80 and the coupler 50 are completely enclosed by (e.g., entirely surrounded by) the dielectric structure DL4 of the build-up layer L4 and the dielectric structure DL5 of the build-up layer L5. The material of the photonic layer 800 including the waveguide 100, the photonic component 80 and the coupler 50 is different from the materials of the dielectric structure DL4 of the build-up layer L4 and the dielectric structure DL5 of the build-up layer L5. In some embodiments, the refractive index of the material of the photonic layer 800 including the waveguide 100, the photonic component 80 and the coupler 50 is higher than the refractive index of the material of the dielectric structure DL4 of the build-up layer L4 and the refractive index of the material of the dielectric structure DL5 of the build-up layer L5. Due to the difference in refractive indices of the materials of the waveguides 100 and the dielectric structures DL4-DL5 of the interconnect 500, the waveguides 100 have high internal reflections such that light is substantially confined within the waveguides 100, depending on the wavelength of the light and the refractive indices of the respective materials. In an embodiment, the refractive index of the material of the waveguides 100 is higher than the refractive index of the material of each of the dielectric structures DL4-DL5. Owing to the waveguide 100, the compact (fan-out) design of an optical network can be achieved, and the power mismatch can be at least less than 0.1 dB. Other configurations (e.g., the angles θ1 through θ7, etc.) or arrangements of the waveguide in the disclosure are possible. For example, the waveguide 100 is embedded in (or saying integrated with) the interconnect 500, as shown in FIG. 14.

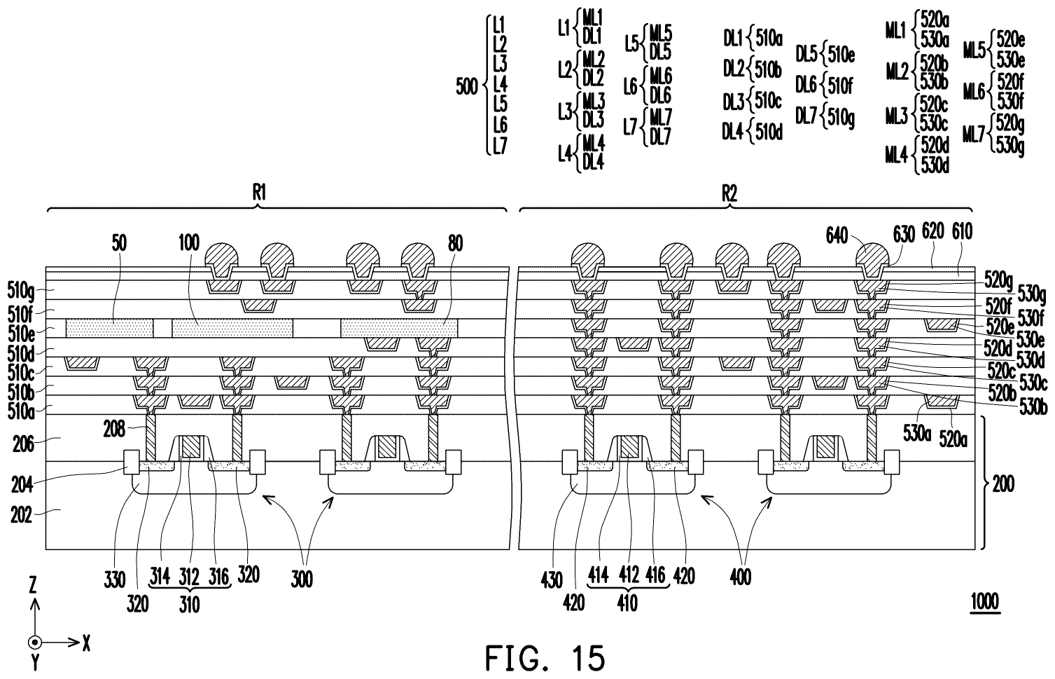

Up to here, the interconnect 500 is manufactured. The interconnect 500 may be referred to as an interconnection, an interconnect structure, a redistribution structure or a routing structure of a semiconductor device 1000 (in FIG. 15) for providing routing functions to the devices and/or the electronic components and/or the photonic components included in the semiconductor device 1000, which not only interconnecting the devices and/or the electronic components and/or the photonic components, but also providing electronic connections to external electronic components or power source(s). Only seven build-up layers (e.g., L1, L2, L3, L4, L5, L6, and L7) included in the interconnect 500 are shown for illustrative purposes, however the disclosure is not limited thereto. The number of the build-up layers of the interconnect 500 may be one, two, three, fourth, five, six, seven, or more than seven, depending on the demand and design requirements. The disclosure is not limited thereto.

Referring to FIG. 15, in some embodiments, a passivation layer 610 and a post-passivation layer 620 are formed over the interconnect 500, in a sequent order along the direction Z. In some embodiments, the passivation layer 610 is disposed on (e.g., in physical contact with) the interconnect 500, and a plurality of first through openings penetrate through the passivation layer 610 to expose portions of a topmost layer of the metallization layers of the interconnect 500 for later electrical connections. Portions of an illustrated top surface (not label) of the conductive layer 530g of the metallization layer ML7 may be accessibly revealed by the first through openings formed in the passivation layer 610, as shown in FIG. 15. In a non-limiting example, the dielectric layer 510g of the dielectric structure DL7 is completely covered by the passivation layer 610, where the conductive layer 530g of the metallization layer ML7 is partially covered by the passivation layer 610, and the seed layer 520g of the metallization layer ML7 is either completely covered, partially exposed or completely exposed by the passivation layer 610. Alternatively, the dielectric layer 510g of the dielectric structure DL7 may be completely covered by the passivation layer 610, where the conductive layer 530g of the metallization layer ML7 may be partially covered by the passivation layer 610, and the seed layer 520g of the metallization layer ML7 may be either completely covered, partially exposed or completely exposed by the passivation layer 610. In other non-limiting example, the dielectric layer 510g of the dielectric structure DL7 is partially covered by the passivation layer 610, where the conductive layer 530g of the metallization layer ML7 is partially covered by the passivation layer 610, and the seed layer 520g of the metallization layer ML7 is either completely covered, partially exposed or completely exposed by the passivation layer 610. Alternatively, the dielectric layer 510g of the dielectric structure DL7 may be partially covered by the passivation layer 610, where the conductive layer 530g of the metallization layer ML7 may be partially covered by the passivation layer 610, and the seed layer 520g of the metallization layer ML7 may be either completely covered, partially exposed or completely exposed by the passivation layer 610. In some embodiments, sidewalls (not label) of the first through openings are slant sidewalls. Alternatively, the sidewalls of the first through openings may be vertical sidewalls.

In some embodiments, the post-passivation layer 620 is disposed on (e.g., in physical contact with) the passivation layer 610, and a plurality of second through openings penetrate through the post-passivation layer 620 to expose the portions of the topmost layer of the metallization layers of the interconnect 500 exposed by the passivation layer 610 for later electrical connections. The portions of the illustrated top surface of the conductive layer 530g of the metallization layer ML7 may be further accessibly revealed by the second through openings formed in the post-passivation layer 620, as shown in FIG. 15. In some embodiments, the second through openings formed in the post-passivation layer 620 are spatially communicated with the first through openings formed in the passivation layer 610, respectively. In a non-limiting example, the post-passivation layer 620 is positioned at an illustrated top surface (not label) of the passivation layer 610, where the sidewalls of the first through openings formed in the passivation layer 610 are free from the post-passivation layer 620, and a lateral size of the second through openings is greater than a lateral size of the first through openings. In other non-limiting example, the post-passivation layer 620 is positioned at the illustrated top surface of the passivation layer 610, where the sidewalls of the first through openings formed in the passivation layer 610 are lined with the post-passivation layer 620, and a lateral size of the second through openings is less than a lateral size of the first through openings. In some embodiments, sidewalls (not label) of the second through openings are slant sidewalls. Alternatively, the sidewalls of the second through openings may be vertical sidewalls.

In some embodiments, the passivation layer 610 and the post-passivation layer 620 independently may be a PBO layer, a PI layer or other suitable polymers. In some alternative embodiments, the passivation layer 610 and the post-passivation layer 620 independently may be made of inorganic materials, such as silicon oxide, silicon nitride, silicon oxynitride, or any suitable dielectric material. The material of the passivation layer 610 and the material of the post-passivation layer 620 may be the same. Alternatively, the material of the passivation layer 610 and the material of the post-passivation layer 620 may be different. For example, the passivation layer 610 is a silicon oxide layer, a silicon nitride layer, a silicon oxy-nitride layer, or a dielectric layer formed by other suitable dielectric materials, and the post-passivation layer 620 is a PI layer, a PBO layer, or a dielectric layer formed by other suitable polymers. In a non-limiting example, the materials of the passivation layers 610 and 620, independently, may be different from the materials of the dielectric layer 510a-510g of the interconnect 500, in part or all. In another non-limiting example, the materials of the passivation layers 610 and 620 may be the same as the materials of the dielectric layer 510a-510g of the interconnect 500. Due to at least one of the passivation layer 610 and the post-passivation layer 620, the semiconductor device 1000 may be protected from damages caused by physically crushes, device transportations, and moistures or hydrogen attacks for the environment, thereby improving the performance of the semiconductor device 1000. In alternative embodiments, at least one of the passivation layer 610 or the post-passivation layer 620 may be omitted.

Continued on FIG. 15, in some embodiments, a plurality of under-ball metallurgy (UBM) patterns 630 and a plurality of conductive terminals 640 are sequentially formed on the post-passivation layer 620 over the passivation layer 610. In some embodiments, the UBM patterns 630 each are disposed between a respective one of the conductive terminals 640 and the post-passivation layer 620. For example, the UBM patterns 630 are disposed on the post-passivation layer 620 and further extend into the second through openings formed in the post-passivation layer 620 and the first through openings formed in the passivation layer 610 to be in (physical) contact with the metallization layer ML7 exposed therefrom so to be electrically connected to the interconnect 500, and the conductive terminals 640 are disposed on (e.g., in physical contact with) and electrically connected to the UBM patterns 630. Due to the UBM patterns 630, the adhesion strength between the conductive terminals 640 and the post-passivation layer 620/passivation layer 610 is enhanced. In some embodiments, the UBM patterns 630 are physically connected to and electrically connected to the interconnect 500. In some embodiments, the conductive terminals 640 are electrically coupled to the interconnect 500 through the UBM patterns 630. In some embodiments, some of the conductive terminals 640 are electrically coupled to the devices formed in the substrate 200 through some of the UBM patterns 630 and the interconnect 500.

In some embodiments, the UBM patterns 630 are made of a metal layer including a single layer or a metallization layer including a composite layer with a plurality of sub-layers formed of different materials. In some embodiments, the UBM patterns 630 include copper, nickel, molybdenum, titanium, tungsten, titanium nitride, titanium tungsten, combinations thereof, or the like. The UBM patterns 630 may include a titanium layer and a copper layer over the titanium layer. The UBM patterns 630 may be formed using electroplating, sputtering, PVD, or the like. For example, the UBM patterns 630 are conformally formed on the post-passivation layer 620 by sputtering to extend on an outermost surface of the post-passivation layer 620 and further extend into the second through openings formed in the post-passivation layer 620 and the first through openings formed in the passivation layer 610, and thus are in physical contact with the portions of the topmost surface of the metallization layer ML7 of the interconnect 500 exposed by the passivation layer 610 and the post-passivation layer 620. The UBM patterns 630 are electrically isolated from one another. The number of the UBM patterns 630 may not be limited in this disclosure, and may correspond to the number of the portions of the topmost surface of the metallization layer ML7 of the interconnect 500 exposed by the passivation layer 610 (e.g., the first through openings formed therein) and the post-passivation layer 620 (e.g., the second through openings formed therein) overlying thereto.

In some embodiments, the conductive terminals 640 are physically connected to and electrically connected to the UBM patterns 630, and are electrically coupled to the interconnect 500 through the UBM patterns 630. In some embodiments, the conductive terminals 640 are disposed on the UBM patterns 630 by ball placement process or reflow process. For example, the conductive terminals 640 includes micro-bumps, metal pillars, electroless nickel-electroless palladium-immersion gold (ENEPIG) formed bumps, controlled collapse chip connection (C4) bumps (for example, which may have, but not limited to, a size of about 80 m), a ball grid array (BGA) bumps or balls (for example, which may have, but not limited to, a size of about 400 m), solder balls, or the like. The disclosure is not limited thereto. The numbers of the conductive terminals 640 is not limited to the drawings of the embodiments, and may be selected and designated based on the demand and design requirements. The number of the conductive terminals 640 may be controlled by adjusting the number of the UBM patterns 630. When solder is used, the solder may include either eutectic solder or non-eutectic solder. The solder may include lead or be lead-free, and may include Sn—Ag, Sn—Cu, Sn—Ag—Cu, or the like. The conductive terminals 640 may be solder free. The conductive terminals 640 may be referred to as conductors, conductive connectors, or conductive input/output terminals of the semiconductor device 1000 for electrical connection with external components or elements (e.g., an additional semiconductor package/device, a circuit substrate, an interposer, a surface mounted device or integrated passive device such as a capacitor, a power source, or the like, etc.).

However, the disclosure is not limited thereto. In some alternative embodiments, the UBM patterns 630 may be omitted. In such alternative embodiments, the conductive terminals 640 may be directly connected to (e.g., in physical contact with) and electrically coupled to the interconnect 500. In further alternative embodiments, the conductive terminals 640 may be omitted, as well.

In some embodiments, a dicing (or singulation) process is sequentially performed to cut through the post-passivation layer 620, the passivation layer 610, the interconnect 500 and the substrate 200 into individual and separated semiconductor devices 1000. Only one semiconductor device 1000 is shown in FIG. 15 for illustrative purposes and simplicity. In one embodiment, the singulation process is a wafer dicing process including mechanical blade sawing or laser cutting. The disclosure is not limited thereto. Up to here, the semiconductor device 1000 is manufactured. In the semiconductor device 1000 of FIG. 15, the region R1 of the photonic integrated die or the PIC is electrically coupled and electrically communicated to the region R2 of the electrical integrated die or the EIC, through the interconnect 500 and the devices (e.g., 300, 400, and so on) formed in the substrate 200. That is, the data signals transmitted to the region R1 of the photonic integrated die or the PIC (e.g., in form of optical signals) would be converted into electrical signals, these electrical signals would then be transmitted to, through the interconnect 500, the region R2 of the electrical integrated die or the EIC for further processing. On the other hands, the data signals (e.g., in form of electrical signals) transmitting from the region R2 of the electrical integrated die or the EIC to the region R1 of the photonic integrated die or the PIC would be converted into optical signals, these optical signals would then be transmitted to, through the photonic layer 800, the external optical (or photonic) devices or components.

In the embodiments of the semiconductor device 1000, the region R1 of the photonic integrated die or the PIC is laterally next to the region R2 of the electrical integrated die or the EIC. In such case, the photonic integrated die or the PIC included in the semiconductor device 1000 is disposed next to the electrical integrated die or the EIC included in the semiconductor device 1000, in the direction X. However, the disclosure is not limited thereto. Alternatively, the photonic integrated die or the PIC included in the semiconductor device 1000 may be disposed next to the electrical integrated die or the EIC included in the semiconductor device 1000, in the direction Y. In another non-limiting example, the region R1 of the photonic integrated die or the PIC is vertically next to the region R2 of the electrical integrated die or the EIC. The region R1 of the photonic integrated die or the PIC may be disposed underneath the region R2 of the electrical integrated die or the EIC, in the direction Z. Alternatively, the region R1 of the photonic integrated die or the PIC may be disposed above the region R2 of the electrical integrated die or the EIC, in the direction Z.

In the embodiments of the semiconductor device 1000, the region R1 of the photonic integrated die or the PIC is integrated with the region R2 of the electrical integrated die or the EIC. However, the disclosure is not limited thereto. In alternative embodiments, the region R2 may be omitted. In such alternative embodiments, the region R2 of the electrical integrated die or the EIC may be in form of an external component device that is electrically coupled and electrically communicated to the region R1 of the photonic integrated die or the PIC.

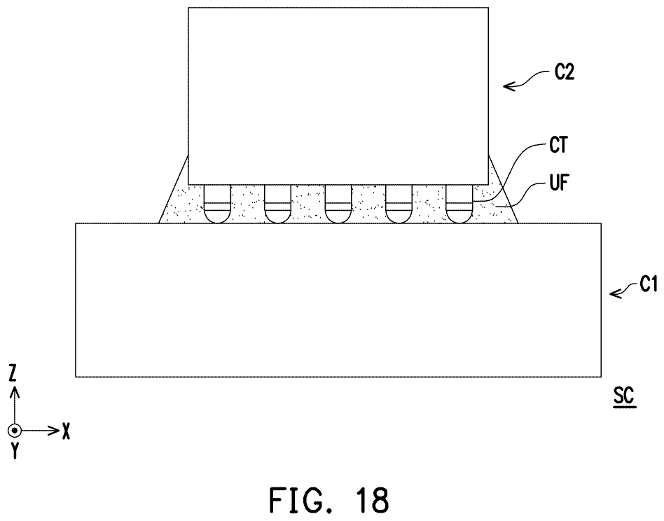

The semiconductor device 1000 and the modifications thereof may be further mounted onto another external electronical component or EIC, for example, mounted onto a circuit structure, such as a mother board, a package substrate, a printed circuit board (PCB), a printed wiring board, and/or other carrier that is capable of carrying integrated circuits; or may be coupled to another external photonic component or PIC. For a non-limiting example, semiconductor device 1000 and the modifications thereof may be or may be part of an integrated Fan-Out (InFO) package, an InFO package having a Package-on-Package (PoP) structure, a chip-on-wafer-on-substrate (CoWoS) package, a flip chip package of an InFO package, or the like. The disclosure is not limited thereto. FIG. 18 is a schematic cross-sectional view showing an application of a semiconductor structure in accordance with some embodiments of the disclosure. The elements similar to or substantially the same as the elements described previously will use the same reference numbers, and certain details or descriptions (e.g., the materials, formation processes, positioning configurations, electrical connections, etc.) of the same elements would not be repeated herein.

Referring to FIG. 18, in some embodiments, a component assembly SC including a first component C1 and a second component C2 disposed over the first component C1 is provided. The first component C1 may be or may include a circuit structure, such as a mother board, a package substrate, another PCB, a printed wiring board, an interposer, and/or other carrier that is capable of carrying integrated circuits. In some embodiments, the second component C2 mounted on the first component C1 is similar to one of the semiconductor device 1000 and the modifications thereof. In a non-limiting example, one or more semiconductor device (e.g., one or multiple semiconductor devices 1000 and/or one or multiple of the modifications of the semiconductor device 1000 may be electrically coupled to the first component C1 through a plurality of terminals CT. The terminals CT may be the conductive elements 640 as described in FIG. 15.

In some embodiments, an underfill UF is formed between the gap of the first component C1 and the second component C2 to at least laterally cover the terminals CT. Alternatively, the underfill UF is omitted. The underfill UF may be any acceptable material, such as a polymer, epoxy resin, molding underfill, or the like, for example. In one embodiment, the underfill may be formed by underfill dispensing, a capillary flow process, or any other suitable method. Owing to the underfill UF, a bonding strength between the first component C1 and the second component C2 is enhanced.

In accordance with some embodiments, an optical waveguide includes a first portion, a second portion, and a third portion. The first portion includes an input port configured to allow an input optical signal of a first propagation direction entering therefrom. The second portion includes a taper waveguide portion configured to expanding the input optical signal and a rectangular waveguide portion configure to split the input optical signal, where the rectangular waveguide portion is connected to the taper waveguide portion. The third portion includes at least one output port configured to allow an output optical signal of an output propagation direction exiting therefrom, where the output propagation direction is different from the first propagation direction. The second portion is sandwiched between the first portion and the third portion.

In accordance with some embodiments, a semiconductor device includes a photonic integrated component including a first semiconductor substrate, a first interconnect, and a photonic layer. The first semiconductor substrate includes a plurality of first devices. The first interconnect is disposed on the first semiconductor substrate and electrically coupled to the plurality of first devices. The photonic layer is embedded in the first interconnect and includes at least one optical waveguide. The least one optical waveguide includes a first portion, a second portion, and a third portion. The first portion includes an input port configured to allow an input optical signal of a first propagation direction entering therefrom. The second portion includes a taper waveguide portion configured to expanding the input optical signal and a rectangular waveguide portion configure to split the input optical signal, where the rectangular waveguide portion is connected to the taper waveguide portion. The third portion includes at least one output port configured to allow an output optical signal of an output propagation direction exiting therefrom, where the output propagation direction is different from the first propagation direction. The second portion is sandwiched between the first portion and the third portion.

In accordance with some embodiments, a method of manufacturing an optical waveguide includes the following steps: providing a base layer; forming a first dielectric layer over the base layer; forming a waveguide material layer over the first dielectric layer; patterning the waveguide material layer to form an optical waveguide comprising a first portion comprising an input port configured to allow an input optical signal of a first propagation direction entering therefrom, a second portion comprising a taper waveguide portion configured to expanding the input optical signal and a rectangular waveguide portion configure to split the input optical signal, and a third portion comprising at least one output port configured to allow an output optical signal of an output propagation direction exiting therefrom, the rectangular waveguide portion being connected to the taper waveguide portion, and the output propagation direction being different from the first propagation direction, where the second portion is sandwiched between the first portion and the third portion; and forming a second dielectric layer over the optical waveguide.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure.

What is claimed is:

1. An optical waveguide, comprising:
a first portion, comprising an input port configured to allow an input optical signal of a first propagation direction entering therefrom;
a second portion, comprising a taper waveguide portion configured to expanding the input optical signal and a rectangular waveguide portion configure to split the input optical signal, the rectangular waveguide portion being connected to the taper waveguide portion; and
a third portion, comprising at least one output port configured to allow an output optical signal of an output propagation direction exiting therefrom, the output propagation direction being different from the first propagation direction;
wherein the second portion is sandwiched between the first portion and the third portion.

2. The optical waveguide of claim 1, wherein an angle between the first propagation direction and the output propagation direction is greater than zero degree and is less than or substantially equal to 180 degrees.

3. The optical waveguide of claim 1, wherein the taper waveguide portion is disposed between and connected to the first portion and the rectangular waveguide portion along a first direction, and the rectangular waveguide portion is disposed between and connected to the taper waveguide portion and the third portion along the first direction,
wherein in the first direction, the taper waveguide portion has a first length, the rectangular waveguide portion has a second length,
wherein a ratio of the first length to the second length is about 2:7 to about 8:9.

4. The optical waveguide of claim 3, wherein the second portion has a length in the first direction and a width in a second direction perpendicular to the first direction, and a ratio of the length to the width is about 3:2 to about 5:2,
wherein the length is a sum of the first length and the second length.

5. The optical waveguide of claim 3, wherein the second portion has a length in the first direction and a width in a second direction perpendicular to the first direction, and a ratio of the length to the width is about 3:2 to about 5:2,
wherein the length is substantially equal to a 3/2 wavelength of the input optical signal.

6. The optical waveguide of claim 1, wherein the output optical signal comprises a first output optical signal and a second output optical signal, and the output propagation direction comprises a second propagation direction and a third propagation direction,
wherein the at least one output port comprises:
a first output port, configured to allow the first output optical signal exiting therefrom with the second propagation direction, the second propagation direction being different from the first propagation direction; and
a second output port, configured to allow the second output optical signal exiting therefrom with the third propagation direction, the third propagation direction being different from the first propagation direction.

7. The optical waveguide of claim 6, wherein an angle between the second propagation direction and the third propagation direction is less than or substantially equal to 360 degrees and is greater than zero degree.

8. An optical waveguide, comprising:
a plurality of optical waveguides of claim 1,
wherein the plurality of optical waveguides of claim 1 are chained to form an optical network, and any two immediately adjacent optical waveguides are coupled to each other by connecting the first portion of one of the any two immediately adjacent optical waveguides to third portion of other one of the any two immediately adjacent optical waveguides.

9. A semiconductor device, comprising:
a photonic integrated component, comprising:
a first semiconductor substrate, comprising a plurality of first devices;
a first interconnect, disposed on the first semiconductor substrate and electrically coupled to the plurality of first devices; and
a photonic layer, embedded in the first interconnect, and comprising:
at least one optical waveguide, comprising:
a first portion, comprising an input port configured to allow an input optical signal of a first propagation direction entering therefrom;
a second portion, comprising a taper waveguide portion configured to expanding the input optical signal and a rectangular waveguide portion configure to split the input optical signal, the rectangular waveguide portion being connected to the taper waveguide portion; and
a third portion, comprising at least one output port configured to allow an output optical signal of an output propagation direction exiting therefrom, the output propagation direction being different from the first propagation direction;
wherein the second portion is sandwiched between the first portion and the third portion.

10. The semiconductor device of claim 9, wherein the photonic layer further comprises:
an optical coupler, optical coupled to the at least one optical waveguide; and
a photonic component, optical coupled to the at least one optical waveguide and electrically coupled to the plurality of first devices through the first interconnect.

11. The semiconductor device of claim 9, further comprising:
a plurality of conductive terminals, connected to and electrically coupled to the first interconnect, wherein the first interconnect is disposed between the first semiconductor substrate and the plurality of conductive terminals.

12. The semiconductor device of claim 9, further comprising:
an electrical integrated component, electrically coupled to the photonic integrated component, comprising:
a second semiconductor substrate, comprising a plurality of second devices; and
a second interconnect, disposed on the second semiconductor substrate and electrically coupled to the plurality of second devices.

13. The semiconductor device of claim 12, further comprising:
a plurality of conductive terminals, connected to and electrically coupled to the first interconnect and the second interconnect, wherein the first interconnect is disposed between the first semiconductor substrate and the plurality of conductive terminals, and the second interconnect is disposed between the second semiconductor substrate and the plurality of conductive terminals.

14. The semiconductor device of claim 12, wherein the first semiconductor substrate and the second semiconductor substrate are an integral piece, the first interconnect and the second interconnect are an integral-piece.

15. The semiconductor device of claim 9, wherein an angle between the first propagation direction and the output propagation direction is greater than zero degree and is less than or substantially equal to 180 degrees.

16. The semiconductor device of claim 9, wherein the output optical signal comprises a first output optical signal and a second output optical signal, and the output propagation direction comprises a second propagation direction and a third propagation direction,
wherein the at least one output port comprises:
a first output port, configured to allow the first output optical signal exiting therefrom with the second propagation direction, the second propagation direction being different from the first propagation direction; and
a second output port, configured to allow the second output optical signal exiting therefrom with the third propagation direction, the third propagation direction being different from the first propagation direction.

17. The semiconductor device of claim 9, wherein the at least one optical waveguide comprises a plurality of optical waveguides,
wherein the plurality of optical waveguides are chained to form an optical network, and any two immediately adjacent optical waveguides are coupled to each other by connecting the first portion of one of the any two immediately adjacent optical waveguides to third portion of other one of the any two immediately adjacent optical waveguides.

18. A method of manufacturing an optical waveguide, comprising:
providing a base layer;
forming a first dielectric layer over the base layer;
forming a waveguide material layer over the first dielectric layer;
patterning the waveguide material layer to form an optical waveguide comprising a first portion comprising an input port configured to allow an input optical signal of a first propagation direction entering therefrom, a second portion comprising a taper waveguide portion configured to expanding the input optical signal and a rectangular waveguide portion configure to split the input optical signal, and a third portion comprising at least one output port configured to allow an output optical signal of an output propagation direction exiting therefrom, the rectangular waveguide portion being connected to the taper waveguide portion, and the output propagation direction being different from the first propagation direction, wherein the second portion is sandwiched between the first portion and the third portion; and
forming a second dielectric layer over the optical waveguide.

19. The method of claim 18, wherein the optical waveguide is formed to have an angle between the first propagation direction and the output propagation direction is greater than zero degree and is less than or substantially equal to 180 degrees.

20. The method of claim 18, wherein the optical waveguide is formed to have the at least one output port comprising a first output port and a second output port,
wherein the output optical signal comprises a first output optical signal and a second output optical signal, and the output propagation direction comprises a second propagation direction and a third propagation direction,
wherein the first output port is configured to allow the first output optical signal exiting therefrom with the second propagation direction, the second propagation direction being different from the first propagation direction, and the second output port is configured to allow the second output optical signal exiting therefrom with the third propagation direction, the third propagation direction being different from the first propagation direction.
